(19) United States
(12) Patent Application Publication
(10) Pub. No.: US 2019/0299925 A1
(43) Pub. Date: Oct. 3, 2019

(54) Child Transportation System

(71) Applicant: Suzhou Swandoo Children's Articles Co., Ltd., Suzhou (CN)

(72) Inventors: Qing Shi, Jiangsu (CN); Nicolas Gonzalez Garrido, Vienna (AT); Vojislav Mokric, Grocka (RS); Srdjan Jovanovic, Zemun (RS)

(21) Appl. No.: 16/299,478

(22) Filed: Mar. 12, 2019

Related U.S. Application Data
(63) Continuation of application No. PCT/CN2017/101460, filed on Sep. 12, 2017.

(30) Foreign Application Priority Data
Sep. 12, 2016 (CN) 201610817633.0
Sep. 12, 2016 (CN) 201621050383.4
Sep. 12, 2016 (CN) 201621050384.9
Sep. 12, 2016 (CN) 201621050426.9
Sep. 12, 2016 (CN) 201621050427.3
Sep. 12, 2016 (CN) 201621050502.6
Sep. 12, 2016 (CN) 201621050638.7
Dec. 26, 2016 (CN) 201621440008.0

(51) Int. Cl. B60R 22/48; B60N 2/28; B60N 2/00

(52) U.S. Cl. CPC B60R 22/48; B60N 2/2845; B60N 2/2893; B60R 2022/4883; B60N 2/2857; B60R 2022/4816; B60R 2022/4866; B60N 2/002

(57) ABSTRACT

A child transportation system is disclosed. The system includes a seating component and various other modules. The system can check whether a seating component is located in a vehicle, whether the seating component is a proper component given the weight and height of the child in the seat, that the seating component is properly secured in the vehicle, and that the system is operating correctly. The system can monitor various conditions of the seat and the environment, and can provide alarms to users when cheks are not completed or dangerous environmental conditions are present, or when a child is left behind in a vehicle.

### CROSS-REFERENCE TO RELATED APPLICATIONS

This application is a continuation of and claims benefit of International Patent Application PCT/CN2017/101460, filed on 12 Sep. 2017, which claimed the benefit of Chinese Utility Model Patent Application No. 201621050502.6, filed Sep. 12, 2016, now pending; Chinese Utility Model Patent Application No. 201621050383.4, filed Sep. 12, 2016, now pending; Chinese Utility Model Patent Application No. 201621050638.7, filed Sep. 12, 2016, now pending; Chinese Utility Model Patent Application No. 201621050427.3, filed Sep. 12, 2016, now pending; Chinese Utility Model Patent Application No. 201621050426.9, filed Sep. 12, 2016, now pending; Chinese Utility Model Patent Application No. 201610817633.0, filed Sep. 12, 2016, now pending; Chinese Utility Model Patent Application No. 201621050384.9 filed Sep. 12, 2016, now pending; the contents of all of which are incorporated herein by reference in their entirety.

### BACKGROUND

The present invention relates to a child safety seat, in particular to a monitoring device for a child safety seat and a control method thereof.

Along with scientific development and the rise of life level, cars are necessary traffic tools for travel. During travel, safety is the first priority. Generally, safety measures on cars such as safety belts and safety airbags are almost always designed according to the figures and weights of adults. Children with a safety belt on their bodies seated in a front seat are in a dangerous position because the figures and weights of children are different from adults. Therefore, if children use the safety measures specially designed for adults, harm cannot be reduced, and on the contrary, the risk of injuring children is increased. Thus, a safety measure specially designed for children is urgently needed.

Child safety seats are tied on automobile seats for children to sit and provided with restraint equipment and can restrain children to guarantee the safety of children to the maximum extent when a car accident happens.

The child safety seats commercially available on the market are different in quality, have relatively single functions, and fail to provide children with better protection. For example, the Chinese patent with patent No. CN 105539345 A, discloses a control device and method for a child safety seat, wherein the control device comprises a weight sensor, a motion sensor, a switching sensor, a processing module, and an alarm. The child safety seat for children has a single function, and can only detect if a child is in a car, detect the running state of the car, and can detect if the child safety belt is correctly buckled. Such child safety seat cannot detect if the environment exceeds the bearing capacities of children and give an alarm, thus endangering the personal safety of children. Meanwhile, the child safety seat described in the patent literature cannot monitor and pre-determine accidents, and cannot report to the police when an accident occurs.

### SUMMARY

The examples disclosed herein provide a monitoring device for a child safety seat and a control method thereof, which can monitor the weight, temperature and location of a child, and more importantly, can monitor accidents according to the motion state of the child safety seat.

A monitoring device for a child safety seat comprises a micro-control processing module, a sensor module, a communication module and a power module, wherein the sensor module is connected with the micro-control processing module; the sensor module comprises a GPS unit, an inertia measuring unit, a temperature measuring unit, a weight measuring unit, a safety belt buckle monitoring unit and a child monitoring unit; the sensor module inputs the detected monitoring information into the micro-control processing module to process the information; the micro-control processing module is connected with the communication module, synchronizes the monitoring information to a client and transmits alarm information through the communication module; and the power module is connected with and supplies power to the micro-control processing module and the communication module.

Preferably, the GPS unit comprises a GPS antenna and a GPS sensor connected with the GPS antenna; the GPS receives satellite signals, and the GPS sensor converts the satellite signals into position information.

Preferably, the inertia measuring unit comprises at least one gyroscope and accelerometer for measuring the motion data of a child; the temperature measuring unit comprises at least one temperature sensor for monitoring the indoor environment of a car; the weight measuring unit comprises at least one pressure sensor for measuring the weight of the child; the safety belt buckle monitoring unit comprises at least one switching sensor for measuring if the safety belt is correctly buckled; and the child monitoring unit comprises at least one distance sensor for measuring if the child is seated on the seat. Alternatively, the child monitoring unit can include a capacitive proximity sensor to determine if a child is occupying the seat.

Preferably, the communication module comprises a GSM communication unit and a Bluetooth communication unit; the GSM communication unit transmits alarm information in the form of text messages, and the Bluetooth communication unit synchronizes the monitoring information to the client.

In one non-limiting example, a control method for the monitoring device for a child safety seat comprises the following steps:

S1, determining if a child is seated on the child safety seat, and if so, executing S2, and if not, stopping the monitoring device;

S2, measuring the weight of the child and determining if the seat requires replacement; and if not, executing S3, otherwise, replacing with a new seat and then executing S3;

S3, determining if the child safety belt is correctly buckled, and if not, transmitting alarm information, or executing S4;

S4, measuring the temperature and determining if the temperature is too high, monitoring accidents and determining if an accident occurs.

Preferably, the step of determining if a child is seated on the child safety seat comprises the following sub-steps:

S101, measuring a distance to obtain a distance value by the distance measuring unit;

S102, determining the distance value, executing S103 when the distance value is smaller than a preset value, or stopping working, by the micro-control processing module;

S103, measuring the weight and determining if the seat requires replacement.

Preferably, the step of determining if the seat requires replacement comprises the following sub-steps:

S201, measuring the weight by the weight measuring unit before the child is seated on the child safety seat;

S202, measuring the weight by the weight measuring unit after the child is seated on the child safety seat;

S203, calculating the weight of the child;

S204, if the weight of the child is greater than a preset value, transmitting information about replacement of a new seat of the next type, or no need to replace the seat.

Preferably, the step of determining if the child safety belt is correctly buckled comprises the following sub-steps:

S301, determining if the safety belt buckle monitoring unit transmits a contact signal;

S302, if the safety belt buckle monitoring unit transmits a contact signal, this means that the safety belt is correctly buckled; or, executing S303;

S303, transmitting information about failure to correctly buckle the safety belt.

Preferably, the step of measuring the temperature and determining if the temperature is too high comprises the following sub-steps:

S401, measuring the car temperature and obtaining the temperature data by the temperature measuring unit;

S402, if the temperature data is greater than a preset value, executing S403, or executing 401-402;

S403, transmitting alarm information about over-temperature.

Preferably, the step of determining if the car has had an accident comprises the following sub-steps:

S501, measuring the chest acceleration of the child and the longitudinal acceleration of the child by the inertia measuring unit;

S502, calculating the time interval required by the chest acceleration of the child to reach a value which is smaller than or equal to 50 g and by the longitudinal acceleration of the child to reach a value which is smaller than or equal to 30 g;

S503, if the time interval is smaller than 3 ms, executing S504, or executing S501-S502;

S504, transmitting accident information to the client.

The present invention has the following beneficial effects:

The child safety seat can monitor the weight, temperature and location of the child by configuration of the monitoring device, and more importantly, can monitor accidents according to the motion state of the child safety seat.

All examples and features mentioned below can be combined in any technically possible way.

In one aspect, a child transportation system includes a seating component for placement in a vehicle in which a child can be placed, a hub for mounting in a vehicle, the hub in wireless communication with the seating component, a key FOB, and a mobile application configured for execution by a remote mobile computing device, wherein the key FOB is in wireless communication with either or both of the hub and seating component, wherein either or both of the hub and seating component are capable of communication with the mobile application, wherein the system is constructed and arranged so that the system can determine if a seating component is properly secured to the vehicle and a child is properly secured to the seating component.

Embodiments may include one of the following features, or any combination thereof. The system is constructed and arranged to perform a plurality of checks comprising one or more checks to determine if the seating component of the child transportation system is located in a vehicle, one or more checks to determine if the seating component is occupied by a child, one or more checks to determine if the seating component is a proper seating component for a child occupying the seating component, one or more checks to determine if the seating component is properly installed in the vehicle, one or more checks to determine if a child located in the seating component is properly secured in the seating component, and one or more checks to determine if the child transportation system is functioning properly.

A check to determine if a seating component of the system is located in the vehicle includes determining if a communication link is present between the hub, when the hub is mounted in the vehicle, and the seating component. A check to determine if the seating component of the system located in the vehicle is occupied by a child includes sensing with an occupancy sensor if the seating component is occupied. A check to determine if the seating component of the system is a proper seating component for a child occupying the seating component includes measuring the child's weight and comparing the measured weight to a stored predetermined threshold weight value. A check to determine if a seating component of the system is a proper seating component for a child occupying the seating component comprises obtaining the child's height and comparing the obtained height to a stored predetermined threshold height value. The child's height is obtained by measuring the child's height by the system. A check to determine if the seating component of the system is properly installed in the vehicle includes determining if the seating component is facing the correct direction in the vehicle, based on the measured weight of the child.

Embodiments may further include one of the following features, or any combination thereof. A check to determine if the seating component of the system is properly installed in the vehicle includes determining by the system if the seating component is located in a front seat of the vehicle, determining by the system if a communication link exists between the system and the vehicle, and wherein if the seating component is determined to be in the front seat and a communication link exists between the system and the vehicle, issuing a command by the system to the vehicle to disable front seat air bags of the vehicle. A check to determine if the seating component of the system is properly installed in the vehicle comprises determining if a handle of the seating component is positioned in a reference position for driving. A check to determine if the seating component of the system is properly installed in the vehicle comprises determining if an Isofix base is present. If an Isofix base is determined to be present, the check to determine if the seating component of the system is properly installed in the vehicle further includes determining if Isofix connectors associated with the Isofix base are properly latched. If an Isofix base is determined not to be present, the check to determine if the seating component of the system is properly installed in the vehicle further comprises determining if a seat belt of the vehicle is properly routed through seat belt routing locations furnished on the seating component. If the seat belt of the vehicle is determined to be properly routed through seat belt routing locations furnished on the seating component, a seating component orientation check is performed.

Embodiments may further include one of the following features, or any combination thereof. A check to determine if the seating component of the system is properly installed in the vehicle includes measuring the tension applied to a harness of the seating component, and determining if the measured tension applied to the harness is greater than a first stored predetermined threshold tension value. The tension is measured using a sensor having a cantilevered beam.

Embodiments may further include one of the following features, or any combination thereof. The system maintains a historical record of checks performed by the system. The historical record includes the output from a GPS sub system included as part of the system.

Embodiments may further include one of the following features, or any combination thereof. The plurality of checks are incorporated into a pre-flight check process which can be initiated by a user prior to the start of a vehicle trip, wherein the pre-flight check can be initiated either by actuation a control surface located on the key FOB or actuation a control surface located on the seating component, wherein execution of the pre-flight check is controlled by the child transportation system, wherein the child transportation system performs the plurality of checks in succession, wherein the child transportation system provides feedback to the user if any check fails to complete, wherein the child transportation system provides feedback to the user that the pre-flight check has passed if all checks included in the plurality of checks complete. A subset of the plurality of checks is incorporated into an automatic check process, wherein the automatic check process is initiated by the child transportation system if a start of a vehicle trip is detected by the system, wherein the start of a vehicle trip is detected by monitoring a GPS sub system incorporated in the child transportation system, wherein execution of the automatic check is controlled by the child transportation system, wherein the child transportation system performs additional checks to determine if environmental conditions are safe, and wherein the child transportation system provides feedback to the user if any check fails to complete.

In another aspect, a method for operating a child transportation system includes determining if a seating component of the child transportation system is located in a vehicle, determining if the seating component of the child transportation system located in the vehicle is occupied by a child, determining if the seating component of the system is a proper seating component for the child occupying the seating component, determining if a seating component of the system is properly installed in a vehicle, determining if a child located in the seating component is properly secured in the seating component, and determining that components of the system are functioning properly.

### BRIEF DESCRIPTION OF THE DRAWINGS

FIG. 1 is a structural block diagram of a monitoring device system of the present invention;

FIG. 2 is a structural block diagram of a wireless charging device of the present invention;

FIG. 3 is a flow chart of a control method for a monitoring device of the present invention;

FIG. 4 is a flow chart of a step for determining if a child is seated on a child safety seat of the present invention;

FIG. 5 is a flow chart of a step for measuring the weight of the child and determining if the seat is required to be replaced of the present invention;

FIG. 6 is a flow chart of a step for determining if a safety belt is correctly buckled of the present invention;

FIG. 7 is a flow chart of a step for determining whether the temperature in a car exceeds scopes of the present invention;

FIG. 8 is a flow chart of a step for determining if an accident occurs of the present invention.

FIG. 9 is a block diagram of one example of a child transportation system.

FIG. 10 is a block diagram schematic of a key FOB used as part of a child transportation system.

FIG. 11 block diagram schematic of a hub used as part of a child transportation system.

FIG. 12 is a block diagram schematic for a main PCB incorporated into a seating component of a child transportation system.

FIG. 13 is a block diagram schematic for a secondary PCB incorporated into a seating component of a child transportation system.

FIG. 14 is a block diagram schematic for a third PCB incorporated into a seating component of a child transportation system.

FIG. 15A is a side view of a seating component of a child transportation system.

FIG. 15B is a rear view of a seating component of a child transportation system.

FIG. 15C is a side view of a seating component of a child transportation system, opposite the side view of FIG. 15A.

FIG. 16 is an exploded view of a key FOB used as part of a child transportation system.

FIG. 17 is an exploded view of a hub used as part of a child transportation system.

FIG. 18 is an enlarged view of a seat belt routing area on the side of a seating component of a child transportation system.

FIG. 19 is a cantilevered sensor for measuring tension of straps of a harness incorporated into a seating component of a child transportation system

FIG. 20 is a flowchart for a pre-flight check of a child transportation system initiated by a button press of a key FOB.

FIG. 21 is a flowchart for a pre-flight check of a child transportation system initiated by a button press on a seating component of the system.

FIG. 22 is a continuation of the flowchart of FIG. 21 for a pre-flight check of a child transportation system initiated by a button press on a seating component of the system.

FIG. 23A is a first portion of a flowchart for a pre-flight check of a child transportation system initiated automatically by the child transportation system.

FIG. 23B is a second portion of a flowchart for a pre-flight check of a child transportation system initiated automatically by the child transportation system.

### DETAILED DESCRIPTION

The technical solution of the embodiment of the present invention is clearly and completely described below in conjunction with the drawings in the embodiment of the present invention.

Elements of figures are shown and described as discrete elements in a block diagram. These may be implemented as one or more of analog circuitry or digital circuitry. Alternatively, or additionally, they may be implemented with one or more microprocessors executing software instructions. The software instructions can include digital signal processing instructions. Operations may be performed by analog circuitry or by a microprocessor executing software that performs the equivalent of the analog operation. Signal lines may be implemented as discrete analog or digital signal lines, as a discrete digital signal line with appropriate signal processing that is able to process separate signals, and/or as elements of a wireless communication system.

When processes are represented or implied in the block diagram, the steps may be performed by one element or a plurality of elements. The steps may be performed together or at different times. The elements that perform the activities may be physically the same or proximate one another, or may be physically separate. One element may perform the actions of more than one block. Audio signals may be encoded or not, and may be transmitted in either digital or analog form. Conventional audio signal processing equipment and operations are in some cases omitted from the drawing.

Embodiments of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

In this embodiment, a child safety seat is taken as an example to describe a monitoring device for a child safety seat of the present invention in detail. Of course, the monitoring device in the present invention can also be installed at child carrying seats such as infant cradles and infant strollers or other devices, which means that the monitoring device is disposed in the infant cradles or infant strollers. Specifically, the child safety seat in this embodiment comprises a seat body and seat lifting rods disposed on the seat body.

More generally, a system is disclosed for child transportation. A child transportation system includes a seating component such as a child seat for use in a motor vehicle, or a child seat for use with a stroller or a bicycle. A single child seat may be useable in more than one type of transportation vehicle where the child seat can be used with a motor vehicle and with a stroller or bicycle. While specific arrangements of modules for a child transportation system are disclosed herein, other arrangement are possible where additional or fewer functions may be incorporated in various modules, and additional modules may be included.

Child transportation systems contemplated herein are constructed and arranged to protect a child. The systems determine if a seating component of the system is located in a vehicle, if the seating component is occupied by a child, if the seating component which the child occupies is proper given the child's weight, height and possibly age. The systems determine if a seating component is properly installed and secured in a vehicle. The systems determine if the child is properly secured in the seating component. The systems determine if various components of the system are functioning properly. Systems contemplated herein check that a proper seating component is used, the seating component is properly installed and the child is secure in the seating component prior to the start of a vehicle trip, and communicate the information to the user. Systems also continuously monitor the status of various components of the system while the vehicle is operating to ensure the system is properly functioning (that all hardware is functioning as intended), and that the system remains properly installed and the child remains properly secured. The system communicates to the user any issues including errors, fault conditions, malfunctions or any other problems with system operation. Child transportation systems disclosed herein monitor if unsafe conditions exist, such as dangerous temperatures or high levels of carbon monoxide (CO) and communicate warnings to a user. Systems monitor whether or not a child is left behind in a vehicle, and communicate warnings to a user when it detects the child has been left behind.

The state of the following quantities can be monitored by the child transportation system by sensing or other methods (such as checks of states within software routines, status of switches, etc.). The quantities can be monitored as part of a pre-flight check which checks and reports status prior to the vehicle starting its trip, so that users know their child is properly secured in a proper seating component, and the seating component is properly oriented and secured within the vehicle. The quantities can also be monitored during normal operation of the vehicle. In one non-limiting example, the following quantities are monitored: ambient temperature in the area of the seating component of child transportation system, carbon monoxide in the area of the seating component of child transportation system, weight and height of the child in the seating component of the child transportation system, occupancy of the seating component of the child transportation system, harness status (including both harness tension and buckle state) of the seating component, vehicle seat belt routing through the seating component, the seating component position in the vehicle, the seating component orientation within the vehicle, position of a seat handle (if present), and presence of and latching status of an Isofix base useable with a seating component of the child transportation system.

Other quantities may be checked and or monitored during a setup or calibration routine, or during operation of the vehicle. A calibration routine is run at the time the hub component of the system is installed in the vehicle. The calibration routine determines a relationship between the location of the hub and the vehicle frame of reference. This allows the child transportation system to know the orientation of a child seat when the seat placed in the vehicle, in the frame of reference of the vehicle. This allows the system to know the orientation of the seat with respect to the vehicle, regardless of the orientation of the vehicle, so that proper orientation can be checked whether the vehicle is sitting flat or is on a hill. The system can check that the child seat is oriented at the proper angle, which seating position of the vehicle the child seat is placed, and the facing direction of the child seat.

In one non-limiting example, a child transportation system includes an accident detection sub system. The accident detection sub system can determine if the vehicle in which the child transportation system is located has been in an accident. The accident detection sub system can use data provided by IMU sensors, 3 axis accelerometers, gyroscopes, or combinations thereof, and may use data from more than one sensor in the determination of whether or not an accident has occurred. The system may detect linear accelerations or decelerations that exceed a predetermined threshold in one or more degrees of freedom. The system may detect rollover conditions, or both accelerations/deceleration and rollover conditions, in one or more degrees of freedom. An accident detection sub system may communicate with other elements of the child transportation system, or with devices remote from the vehicle, using any of the communications methods and protocols described herein.

In one non-limiting example, if a seating component has been involved in an accident, as detected by the accident detection system, the seating component's serial number is uploaded to a remote database, and is identified as having been in an accident. Additionally, the seating component can set an internal flag that identifies the seating component as having been in an accident. If the seating component is ever sold, a purchaser can query the remote database to determine if the seating component has been in an accident. By setting an internal flag, the seating component can identify a user that it has been involved in an accident whenever the seating component or an element of the system in which the seating component resides communicates with a user's remote mobile computing device (smartphone). Whenever the mobile app. is engaged, the seating component can identify to the app. that the seating component has been involved in an accident. Alternatively or additionally, LED's on the seating component can flash red in a pattern that is identified with having been in an accident, an audible alarm can sound, or any other known method of communicating the information to a user can be employed by the system to ensure a seating component used in an accident is not used.

In one non-limiting example, a child transportation system includes a GPS sub system. The GPS sub system received information from GPS satellites and provides location information for use by other modules in the system. For example, upon detection that the child transportation system has been in an accident, when the child transportation system notifies a remote device of the accident, it provides GPS location data along with the notification so that remote individuals, first responders, or emergency contacts know the location of the accident.

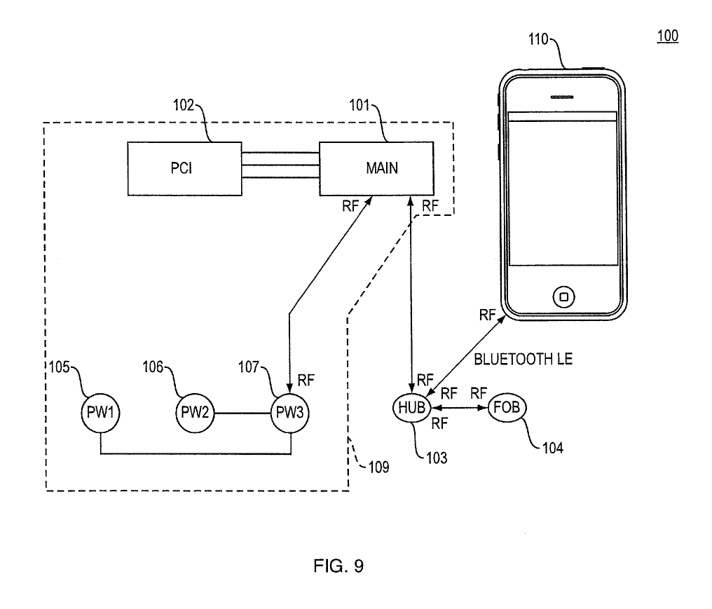

In one non-limiting example, a child transportation system maintains a history of data collected. A device operating history can be useful as forensic evidence in the case of an accident, injury or death. The system records data on the results of checks of the system, which can be pre-flight checks initiated by a used, automatic checks initiated by the system, and ongoing operational checks. The various checks check that a proper seating component is used, the seating component is properly secured in a vehicle, the child is properly secured in the seating component, and the system components function properly. The system can record a data history from various sensors, such as GPS, temp., CO sensors and the like. History information from these sensors can also provide forensic benefit. The data can be stored locally, or can be transmitted to a mobile system interface and control app. running on mobile device 110, as shown in FIG. 9. By offloading data to the mobile device, large data storage is not required on within the child transportation system. History data can be maintained in a FIFO arrangement where at any one time up to a predetermined time period of data is held. The time period chosen is not limited, and system designers can choose whatever time period they desire. In one non-limiting example, the time period is 6 months.

In one non-limiting example, a child transportation system includes a hub which is separate from a child seat, where the child seat and hub are capable of communicating with each other. A child seat and/or a hub can communicate with a smartphone device, where information communicated between the child seat or hub may include the status of the seat or other system components, and the information may also include commands to control various portions of the system, as will be described in more detail in subsequent sections. A system can communicate with remote devices in locations other than the location of the child transportation device. For example, the child transportation device may notify emergency contacts, police or first responders in case of an accident.

In one non-limiting example, child transportation system can include a key FOB, where the key FOB can issue commands to elements of the system and/or receive information such as status of elements of the system from system modules. The key FOB may wirelessly communicate with the hub or the child seat, or both.

Examples of child transportation devices disclosed herein that consist of more than a single module are not limited in the manner in which communications between the various modules are implemented. Communication may be wired or wireless, where wireless communication links may use any known wireless protocol. For example, communication between modules could be optical or RF, where RF communication could use any known wireless communication protocol such as wi-fi based on any version of the IEEE 802.11 standard. The RF protocol could also be proprietary or based on any other known transmission protocol such as any known version of Bluetooth, Zig Bee, etc. Different modules may communicate using different protocols. For example, a key FOB may communicate with a hub via a proprietary wireless spread spectrum protocol, while the hub may communicate with a seat via a Bluetooth protocol and with a mobile device via a Bluetooth or GSM or other cellular network communication protocol. Examples disclosed herein are not limited in the protocol chosen for any specific communication link.

In one non-limiting example, communication between some modules of a child transportation system is wireless while communication between other modules is made via a wired connection. For example, as will be described in more detail later, a sensor module can have a wired connection to a processing module.

In one non-limiting example, GSM communication is incorporated to allow a module or modules of the child transportation system to communicate via the cellular network. Communication can be via SMS text messages, voice or data cellular transmission, email, or any other messaging or communication method known for use with cellular networks. Communication may be between modules of the child transportation system, or between a module of the child transportation device and a remote device such as a remotely located smartphone, tablet, or computer.

In one non-limiting example, a child transportation system includes rechargeable batteries to provide power to various components of the system. The batteries can be recharged by connecting a battery charger to the system component incorporating the rechargeable batteries. Alternatively, the system may be arranged to accommodate wireless charging. A seating component of the vehicle may be recharged when it is removed from a vehicle and connected to a wired or wireless charger in the user's home. Alternatively, a wired or wireless charger can be connected to a vehicle's power system so that the vehicle can provide power to the seating component through the wireless charger. Child transportation systems that incorporate rechargeable batteries include battery monitoring sub systems to monitor the state of battery charge, so that a user can be signaled of a low battery charge condition.

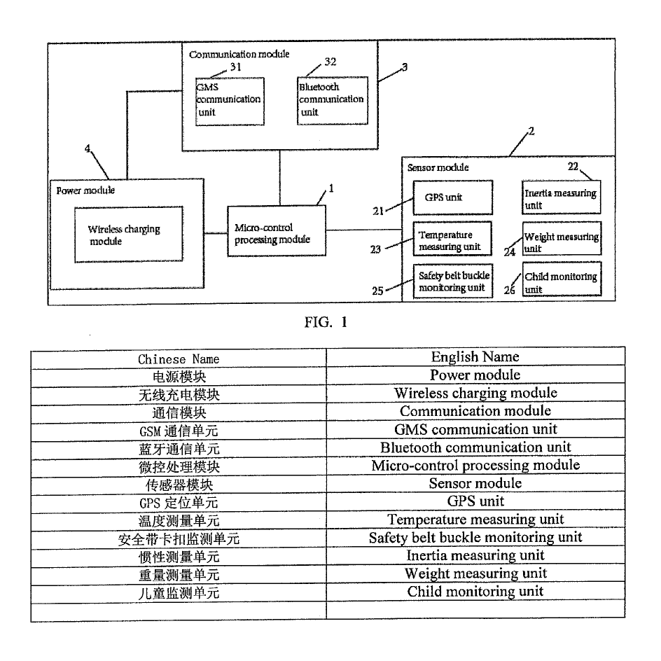

As shown in FIG. 1, one non-limiting example of a monitoring device for a child safety seat is shown. Preferably, the monitoring device for a child safety seat is disposed on a seat body. The monitoring device comprises a micro-control processing module 1, a sensor module 2, a communication module 3 and a power module 4, wherein the sensor module 2 is connected with the micro-control processing module 1, inputs the detected monitoring information into the micro-control processing module 1 to carry out corresponding processing; the communication module 3 is connected with the micro-control processing module 1; the micro-control processing module 1 synchronizes monitoring information to a client and transmits alarm information through the communication module; and the power module 4 is connected with and supplies power to the micro-control processing module 1 and the communication module 3 to ensure normal working of the micro-control processing module 1 and the communication module 3.

The sensor module 2 comprises a GPS unit 21, an inertia measuring unit 22, a temperature measuring unit 23, a weight measuring unit 24, a safety belt buckle monitoring unit 25 and a child monitoring unit 26. Further, the GPS unit 21 detects the position information of the child safety seat, and can quickly and accurately locate an accident to assist rescue in time when an accident has occurred. The GPS unit 21 comprises a GPS antenna and a GPS sensor which is connected with the GPS antenna; the GPS receives satellite signals; the GPS sensor converts the satellite signals into position information and inputs the position information into the micro-control processing unit 1. When an accident occurs, the micro-control processing module transmits the positioning information to the client through the communication module 3; when no accident occurs, the child safety seat can also be precisely positioned. Preferably, the GPS antenna is disposed on the seat lifting rods of the child safety seat. Of course, the GPS antenna can also be disposed on the seat body.

The inertia measuring unit 22 comprises at least one gyroscope and accelerometer for measuring the motion data of a child; the gyroscope and the accelerometer can measure the acceleration of the chest of a child, which is recorded as a_{chest}, and can measure the acceleration of the child in the longitudinal (Z-axis) direction, which is recorded as a_{z}, at the same time. The child motion data, namely a_{chest} and a_{z}, measured by the inertia measuring unit 22 is transmitted to the micro-control processing module 1 to be correspondingly processed and the processing results are used to determine if an accident has occurred.

The temperature measuring unit 23 comprises at least one temperature sensor for monitoring the temperature environment in a car and inputting the measured temperature data into the micro-control processing module 1; the micro-control processing module 1 processes the measured temperature data, determines if the temperature is too high, and transmits the alarm information through the communication module 3 when the temperature is too high.

The weight measuring unit 24 comprises at least one pressure sensor; the pressure sensor can convert a pressure into a varying physical quantity of a force, namely the weight described in this embodiment; and the pressure sensor is preferably a piezoresistive pressure sensor. Preferably, the weight measuring unit 24 is disposed in the middle of each one of the lifting rods of the child safety seat; when the seat is lifted through the seat lifting rods, palms pinch the pressure sensor in the weight measuring module by the effect of the seat weight, and the pressure sensor detects the pressure, converts the pressure into weight data, and inputs the weight data into the micro-control processing module for further processing. Of course, the weight measuring unit can also be disposed at the bottom of the seat body to measure the weight of child.

The safety belt buckle monitoring unit 25 comprises at least one switching sensor for detecting if a safety belt is correctly buckled; the switching sensor transmits contact signals; when the tongue of the safety belt contacts a contact point of a receptacle, the switching sensor transmits the contact signals to the micro-control processing module to carry out corresponding processing.

The child monitoring unit 26 comprises at least one distance sensor. Preferably, the distance sensor is disposed in the middle of each one of the lifting rods of the child safety seat, and the distance sensor inputs the measured distance between the top of the each one of the seat lifting rods and the bottom of the seat into the micro-control processing module 1 to further determine if a child is seated on the child safety seat.

The communication module 3 comprises a GSM communication unit 31 and a Bluetooth communication unit 32; the GSM communication unit 31 comprises a GSM antenna and a GSM transmitting unit; the GSM communication unit 31 can transmit weight information, temperature information, position information and accident information to the client, and the Bluetooth communication unit 32 can synchronize the monitoring information detected by the sensor module into the client.

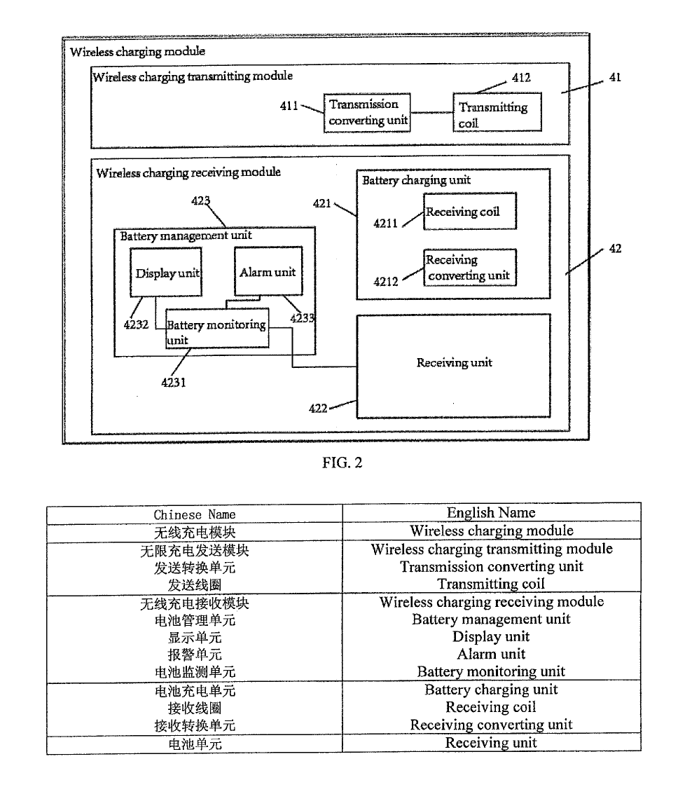

Refer to FIG. 1 and FIG. 2 together. In this embodiment, the power module 4 is preferably charged in a wireless way; the power module 4 is connected with and supplies power to the micro-control processing module 1 and the communication module 3 to ensure the normal working of the micro-control processing module 1 and the communication module 3. The power module 4 comprises a wireless charging module; the wireless charging module comprises a wireless charging transmitting module 41 and a wireless charging receiving module 42; the wireless charging transmitting module 41 is installed on the car seat; the wireless charging receiving module 42 is disposed on the seat body of the child safety seat; the wireless charging transmitting module 41 and the wireless charging receiving module 42 are wirelessly connected to perform charging. The child safety seat can be charged when placed on a car seat and is not charged when away from the car seat, which is convenient and quick and effectively saves cost.

Specifically, the wireless charging transmitting module 41 comprises a transmission converting unit 411 and a transmitting coil 412 which is connected with the transmission converting unit 411; and the transmission converting unit 411 converts an electrical current into electromagnetic waves and transmits the electromagnetic valves out through the transmitting coil 412.

The wireless charging receiving module comprises a battery charging unit 421, a battery unit 422 and a battery management unit 423; the battery charging unit 421 is connected with the battery unit 422 for the purpose of charging the battery unit 422; and the battery management unit 423 is connected with the battery unit 422 for the purpose of monitoring and managing the battery unit 422.

The battery charging unit 421 comprises a receiving converting unit 4211 and a receiving coil 4212 connected with the receiving converting unit 4211; the receiving coil 4212 receives the electromagnetic waves sent by the transmitting coil 412 and transmits the received electromagnetic waves to the receiving converting unit 4212; and the receiving converting unit 4212 converts the electromagnetic valves into an electrical current and inputs the electrical current into the battery unit 422 to charge the battery unit 422.

The battery management unit 423 comprises a battery monitoring unit 4231, a display unit 4232 and an alarm unit 4233, wherein the battery monitoring unit 4231 is connected with the battery unit 422 for the purpose of monitoring the electric quantity information of the battery unit; the battery monitoring unit 4231 is connected with the display unit 4232 to display the electric quantity information in the display unit; meanwhile, the alarm unit 4233 is connected with the battery monitoring unit 4231, when the battery monitoring unit 4231 detects that the battery unit 422 has low power, the alarm unit 4233 transmits alarm information. Specifically, the alarm unit 4233 comprises a plurality of buzzers, and when the power is low, the buzzers can sound to remind the user to charge the device.

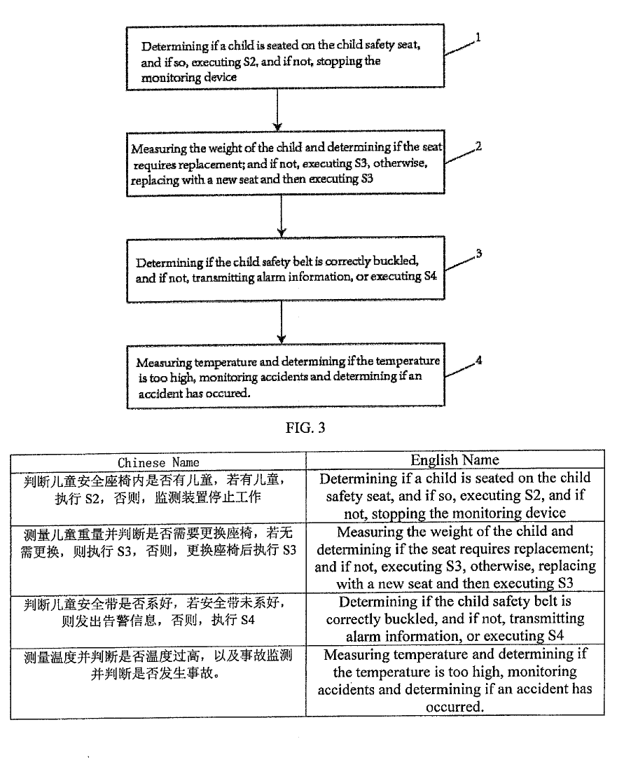

As shown in FIG. 3, a control method for the monitoring device for a child safety seat comprises the following steps:

S1, determining if a child is seated on the child safety seat, and if so, executing S2, and if not, stopping the monitoring device;

S2, measuring the weight of the child and determining if the seat requires replacement; and if not, executing S3, or replacing with a new seat and then executing S3;

S3, determining if the child safety belt is correctly buckled, and if not, transmitting alarm information, or executing S4;

S4, measuring the temperature and determining if the temperature is too high, monitoring accidents and determining if an accident has occurred.

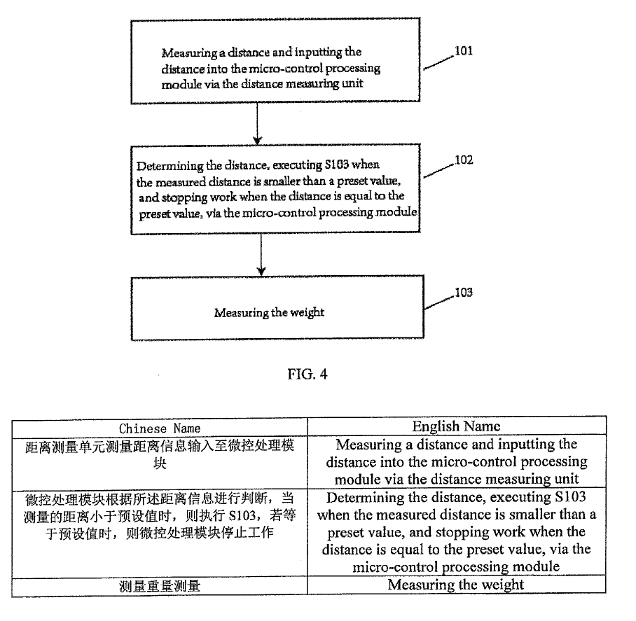

Specifically, as shown in FIG. 4, the step of determining if a child is seated on the child safety seat comprises the following sub-steps:

S101, measuring a distance and inputting the distance into the micro-control processing module by the distance measuring unit;

S102, determining the distance, executing S103 when the measured distance is smaller than a preset value, and stopping working when the distance is equal to the preset value, by the micro-control processing module;

S103, measuring the weight.

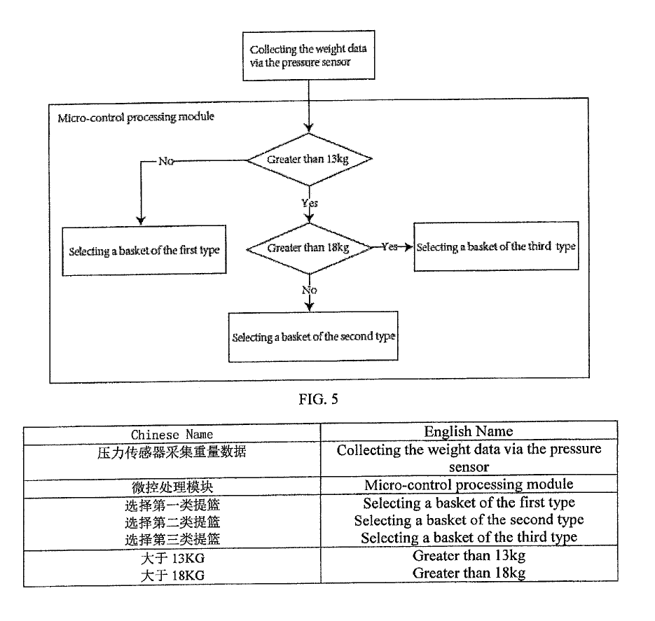

FIG. 5 is a flow chart of measurement of the weight of the child and determination of if the seat requires replacement. Specifically, the step of measuring the weight of the child and determining if the seat requires replacement comprises the following sub-steps:

S201, measuring the weight with the weight measuring unit before the child is seated on the child safety seat, wherein specifically, the weight measuring module measures and obtains the weight data through the pressure sensor, records the weight data as the first weight data G1, and the first weight data is outputted and stored in the micro-control processing module;

S202, measuring the weight by the weight measuring unit after the child is seated on the child safety seat, wherein specifically, the weight measuring module measures and obtains a weight data through the pressure sensor after the child is seated, and records the weight data as the second weight data G2, and the second weight data is inputted into and stored in the micro-control processing module;

S203, calculating the weight of the child, wherein specifically,

the micro-control processing module calculates the weight data of the child according to the weight data obtained after two measurements, and records the weight of the child as G3, wherein,

G3=G2−G1;

G3 represents the weight of the child, G2 represents the weight data measured and obtained after the child is seated, G1 represents the weight data measured and obtained before the child is seated;

S204, if the weight of the child is greater than a preset value, transmitting seat replacing information, or no need to replace the seat, wherein specifically, the micro-control processing module determines if the seat requires replacement according to the weight data of the child, the micro-control processing module determines if the current G3 is greater than a preset value, preferably 13 Kg, 18 Kg, 36 Kg in this embodiment, and if the weight data is not greater than 13 Kg, this means that the seat is currently suitable for the child; if the weight data is greater than 13 Kg, the micro-control processing module further determines if the weight data is greater than 18 Kg, if the weight data is smaller than 18 Kg, this means that the seat is currently not suitable for the child, and a seat of a second type is required; and if the weight data is greater than 18 Kg, this means that a seat of a third type is required.

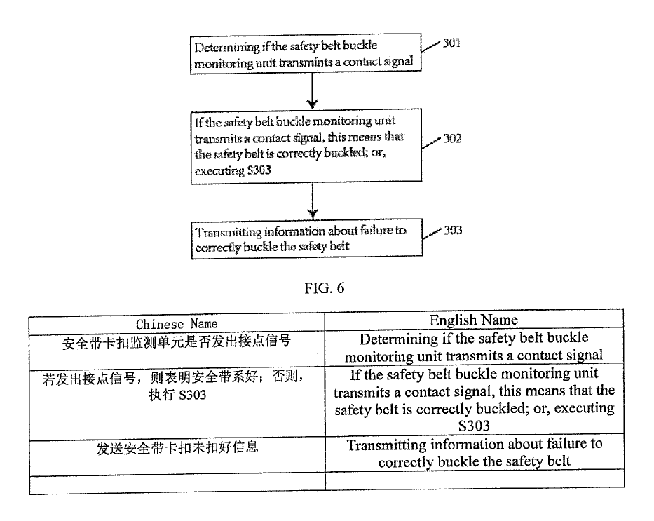

As shown in FIG. 6, the step of determining if the child safety belt is correctly buckled comprises the following sub-steps:

S301, determining if the safety belt buckle monitoring unit transmits a contact signal;

S302, if the safety belt buckle monitoring unit transmits a contact signal, this means that the safety belt is correctly buckled; or, executing S303;

S303, transmitting information about failure to correctly buckle the safety belt, wherein specifically,

the safety belt buckle monitoring unit comprises at least one switching sensor; the tongue of the safety belt and the receptacle are internally provided with matched contact points; when the tongue of the safety belt is inserted into the receptacle and the contact points touch each other, the switching sensor transmits a contact signal to the micro-control processing module; when the contact point on the tongue of the safety belt does not contact the contact point in the receptacle, which means that the micro-control processing module does not receive the contact signal, the communication module transmits the alarm information to the client to inform the client that the safety belt is not correctly buckled, and usually, the client is a mobile phone.

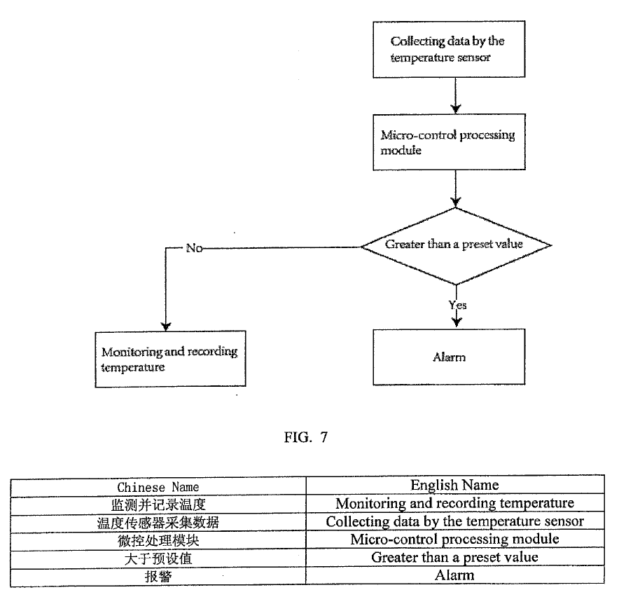

FIG. 7 is a flow chart of temperature measurement and determination of over-temperature. Specifically, the step of measuring the temperature and determining if the temperature is too high comprises the following sub-steps:

S401, measuring a car temperature and obtaining a temperature data by the temperature measuring unit;

S402, if the temperature data is greater than a preset value, executing S403, or executing 401-402;

S403, transmitting alarm information about over-temperature, wherein specifically, first, the temperature sensor measures the indoor temperature of the car, obtains the temperature data and inputs the temperature data into the micro-control processing module;

then, the micro-control processing module processes the temperature data, specifically, compares the temperature data with a preset temperature value in the micro-control processing module, preferably 38° C. in this embodiment. The micro-control processing module enables the communication module to transmit alarm information if the temperature data is greater than the preset temperature value, or records the temperature data and transmits the temperature data into the client through the Bluetooth communication unit to visually display the temperature data if the temperature data is smaller than the preset temperature value.

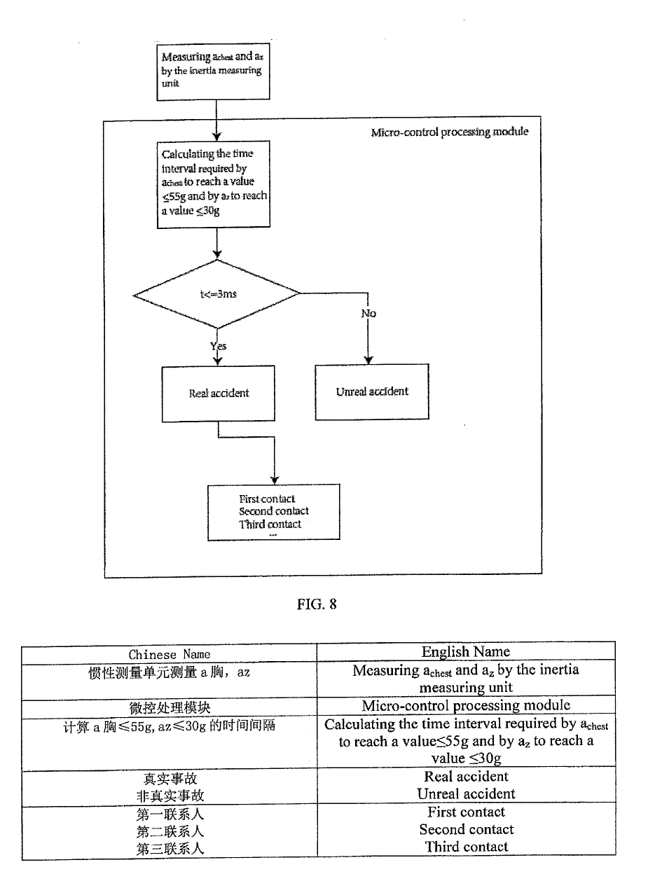

FIG. 8 is a flow chart of determination on occurrence of car accidents. The step of determining if the car has had an accident comprises the following sub-steps:

S501, measuring the chest acceleration of the child and the longitudinal acceleration of the child by the inertia measuring unit;

S502, calculating the time interval required by the chest acceleration of the child to reach a value which is smaller than or equal to 50 g and by the longitudinal acceleration of the child to reach a value which is smaller than or equal to 30 g;

S503, if the time interval is smaller than 3 ms, executing S504, or executing S501-S502;

S504, transmitting accident information to the client, wherein g represents gravitational acceleration, specifically, first, the inertia measuring unit measures the chest acceleration of the child, namely a chest and the longitudinal (Z-axis) acceleration of the child, namely az;

then, the micro-processing module, according to a_{chest} and a_{z}, calculates the time interval t required by a_{chest} to reach a value ≤50 g and by a_{z} to reach value ≤30 g, wherein g represents the gravity acceleration; when t≤3 ms, this means a real accident has occurred, in such circumstances, the micro-control processing unit starts contact searching to search contacts preset in the micro-control processing units and transmits the accident information to a searched contact, wherein the contacts include policemen, parents, etc. and the accident information comprises the position information measured by the GPS unit; the contact transmits a return receipt to the micro-control processing module after receiving the accident information; then, the micro-control processing module stops searching contacts; in the case of not receiving the return receipt within a certain period of time, the micro-control processing module continues to search the preset contacts and transmit accident information until receiving the return receipt;

when t>3 ms, this means that no accident has occurred, and the micro-control processing module continues to calculate the time interval required by a_{chest} to reach a value ≤50 g and by a_{z} to reach a value ≤30 g.

The child safety seat can monitor the weight, temperature and location of the child by configuration of various monitoring devices, and more importantly, can monitor accidents according to the motion state of the child safety seat.

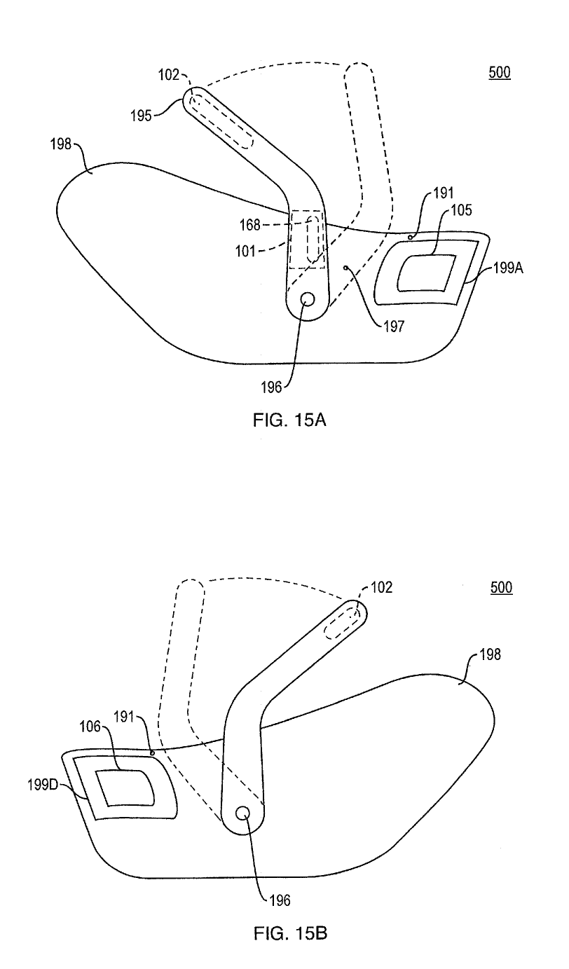

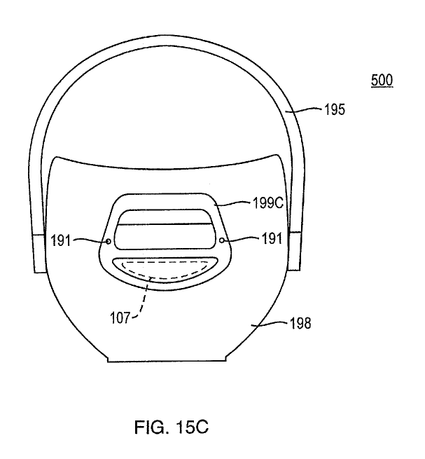

FIG. 9 depicts a block diagram of one non-limiting example child transportation system 100 which includes a number of modules. The components of system 100 that are incorporated on a seating component are surrounded by dotted line 109. Main PCB 101 and PC1 PCB 102 are located on a seating component (for example seating component 500 of FIGS. 15A-C, where FIGS. 15 A and 15B show left and right-side views and 15C shows a rear view of seating component 500) of child transportation system 100. PCB's 105 and 106 are located on the sides of a seating component of system 100 near routing points for a vehicle lap belt. PCB 107 is located on the rear portion of a seating component of system 100, near routing locations of a vehicle shoulder belt. Hub 103 is arranged to be affixed to a rear window of a vehicle. Key FOB 104 is designed to be carried by a user, as is mobile device 110.

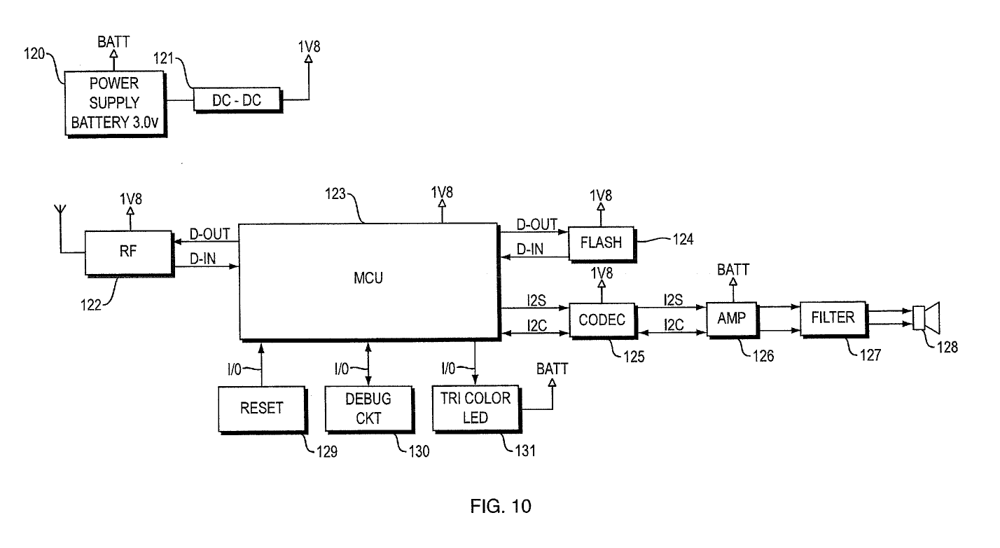

In one non-limiting example, system 100 includes key FOB 104. FIG. 10 depicts a block diagram of FOB 104 and is discussed in more detail below. Key FOB 104 wirelessly communicates with hub 103, though systems are not limited to this arrangement (for example, key FOB 104 could communicate with seat main PCB 101 or PC1 PCB 102, which could then communicate with hub 103). Communication between key FOB 104 and hub 103 is beneficial as hub 103 can be configured to communicate with more than one seating component located in the same vehicle. In the case where the child transportation system 100 includes more than one seating component which can be used in the same or different vehicles, a single key FOB can be used with more than one seating component so that separate key FOBs are not required for each seating component. A seating component, a hub and a key FOB can come from a factory already paired together so that the user need not perform any pairing operation to initiate communication between the elements. A second seating component can be added, where the second seating component can also be paired with the hub. A single key FOB can then be used to control and/or receive and display information from either of the paired seats. A user will need to pair their mobile device with the system in some manner if communication between their mobile device and the system 100 is desired. It should be noted here that the act of “pairing” refers to taking an action that allows a first wireless device to find compatible wireless devices and establish a connection therebetween. Methods of pairing wireless devices are well known in the art and will not be described further.

FIG. 10. Depicts a block diagram for one non-limiting example of a key FOB (such as key FOB 104 of FIG. 9). The power supply of FOB 104 includes battery 120 and DC-DC converter 121. Power output from converter 121 is provided to the other electrical components of FOB 104. Also included in FOB 104 is micro controller 123, which in one non-limiting example is an STM32L062C6 microcontroller available from ST microelectronics, headquartered in Geneva, Switzerland. Micro 123 controls the various functions of FOB 104 through numerous peripheral devices. Transceiver 122 provides a bi-directional RF communication interface for micro 123, allowing FOB 104 to wirelessly communicate with hub 103. Software instructions and data are stored in and can be fetched from flash memory 124. FOB 104 is capable of providing an audible output. Micro 123 outputs data to codec 125. Codec 125 provides its output to amplifier 126. The output of amplifier 126 is filtered by EMI filter 127 before being provided to loudspeaker 128 which produces audible output. Also connected to micro 123 is tri-color LED 131, which is used to display information to a user. LED 131 is controlled by micro 123 and can be caused to change color to indicate the status of various portions of child transportation system 100. Debug circuit 130 is included which is useful in development. Reset 129 is a manually operated switch useable as a control surface for FOB 104 to accept input from a user.

In one non-limiting example, key FOB 104 includes a control surface of some type which may be a single button, multiple buttons, or some other type of control surface such as a touch screen, and a visual output device of some type which may be a simple LED, a series of LED's, or one or more multi-colored LED's where different colors can be used to indicate different information. A key FOB could include some other type of display such as an LCD, OLED, or other type of graphical display. A key FOB could include an audio sub system which may include a microphone for accepting voice input and a loudspeaker for outputting audible information. A key FOB configured to accept voice input information may be capable of processing voice input itself or may send voice information to another component of the system for processing, where the processing includes voice recognition, where the voice recognition output is in the form of commands for execution by the child transportation system. In one non-limiting example, the key FOB includes a processor capable of performing voice recognition on the received voice input. Alternatively, the key FOB could provide the voice data to another component of the system via a wireless link of some type (RF, Bluetooth, etc.) for speech recognition and processing.

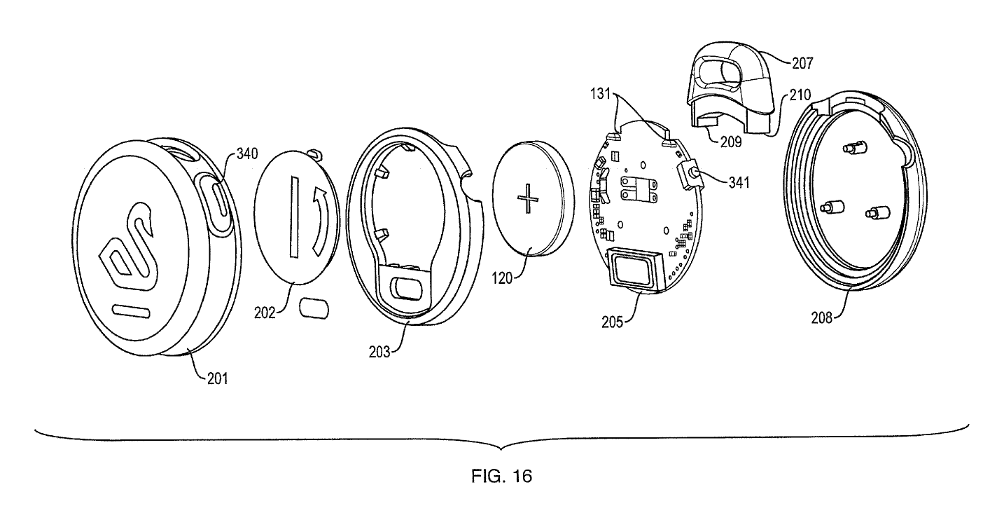

FIG. 16 depicts an exploded view of one non-limiting example of key FOB 104. PCB 205 incorporates the elements of the block diagram depicted in FIG. 10. FOB 104 includes front cover 201 and back cover 208 which enclose the various components of FOB 104. Housing 203 provides locating features to hold battery 120 in place. Battery cover 202 provides access to battery 120 to allow a user to change the battery when necessary. Ring 207 has a hole therethrough to allow FOB 104 to be affixed to a user's key ring. Ring 207 is also transparent or translucent and acts as a light pipe. Feet 209 and 210 sit above tri-color LED's 131 and conduct light output from LED's 131 into the body of ring 207 so that ring 207 lights up when LED's 131 are lit.

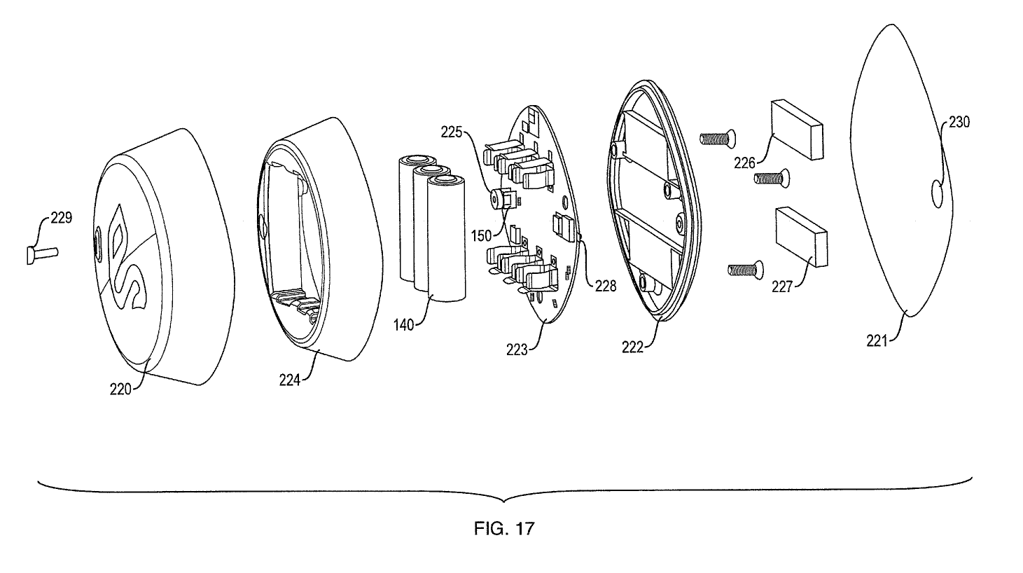

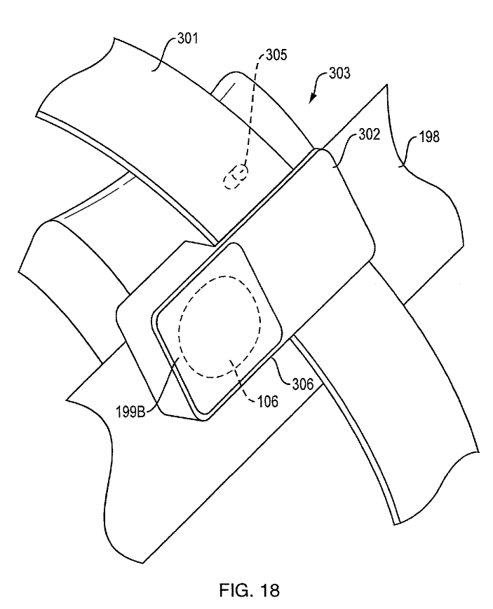

Child transportation system 100 further includes hub 103. Hub 103 communicates with various elements of system 100, and also communicates with remotely located devices. An exploded view of one non-limiting example of hub 103 is shown in FIG. 17. Hub 103 includes covers 220 and 222 which enclose hub 103 hardware. Frame 224 provides a compartment for batteries 140, where the user can remove cover 220 to obtain access to the battery compartment in order to change batteries 140. Lighted mechanical switch 225 is aligned with transparent or translucent switch actuator 229. Actuator 229 provides a control surface for a user (a button which can be pressed), for hub 103 to accept input from a user. Lighted switch 225 incorporates both a mechanical push activated switch and LED 150. LED 150 outputs light into actuator 229 lighting up actuator 229. The presence of, and color of the light output from LED 150 of switch 225 can be used to provide information or feedback to the user of various conditions within the hub 103 or the system 100 as a whole.

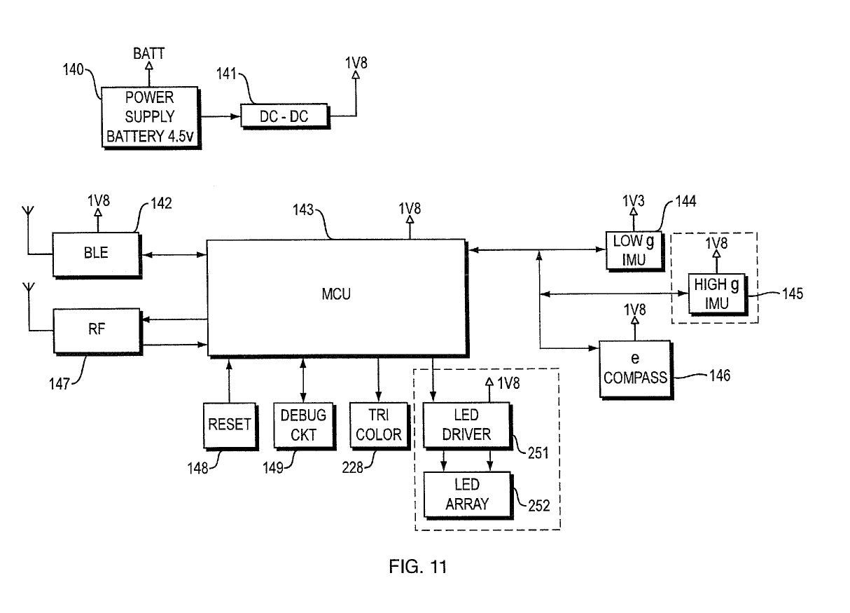

PCB 223 contains the circuitry for performing the functions of hub 103. A block diagram of the hub circuitry is shown in FIG. 11, and is described in more detail below. Hub 103 is affixed to an interior surface of a rear facing window of a vehicle. Mount 221 is affixed to the interior surface of the vehicle rear window. Hub 103 is removably attached to mount 221 using Velcro strips 226 and 227, where the Velcro strips 226 and 227 couple between a back side of rear housing 222 and a vehicle interior facing side of mount 221. Though a Velcro attaching mechanism is shown, it should be understood that any removable latching mechanism known in the art could be used here to removably attach hub 103 to mount 221. Hub 103 contains a display that is visible from outside the vehicle through the rear window to which hub 103 is mounted, such that hub 103 can communicate information to individuals located outside the vehicle. LED 228 is mounted on the back side of PCB 223.

Hole 230 of mount 221 is aligned with LED 228. A hole in rear cover 222 is also aligned with LED 228. By mounting LED 228 on the rear side of PCB 223 and aligning holes as shown, LED 223 will be visible from outside and behind the vehicle through the rear window. Although holes are shown, transparent windows could be formed in mount 221 and rear housing 222, or the entirety of these housings could be made transparent such that light emitting components mounted on the rear facing side of PCB 223 are visible from behind the vehicle when hub 103 is mounted to the interior surface of the rear window as intended. LED 228 can also be used to illuminate a larger area light plate affixed to the back of the hum. Rather than having a simple LED, the entire light plate is illuminated by LED 228. Graphic images can be etched on the light plate so that the image becomes visible when the plate is illuminated.

Rather than the simple LED 228 shown in FIG. 17, a more complex visible display device could be mounted to the rear side of hub 103 so that it is visible outside the vehicle. For example, an alphanumeric or graphical display could be mounted to the rear side of PCB 223, with necessary portions of rear housing 222 and mount 221 made transparent (or having holes) to allow the display to be seen from behind. An E-ink display can be used for improved visibility in daylight. An optional display including LED driver 251 and LED array 252 is shown as part of the hub 103 block diagram in FIG. 11. The display could notify people external to the vehicle that a “Baby is on Board”, or could indicate that a dangerous or emergency condition exists in the vehicle. The display could output any desired call to action. The display could output the child's important medical data such as blood type. The hub display may be an LED array such as array 252 which can display alphanumeric information, or a more sophisticated display such as an LCD or OLED capable of displaying images as well as text, where the display can be in full color or monochrome (for example, a single color such as Red). Hub 103 may include an audio output such that audible information can be output. For example, hub 103 could audibly communicate the status of various system elements to a user, or output a sequence of steps for a user to follow in during setup and/or operation of the system.

Hub 103 communicates wirelessly with other components of the system 100. As shown in FIG. 9, hub 103 communicates wirelessly with PCB 101, with mobile device 110 (which can be a smart phone, a tablet or other mobile device), and with key FOB 104. Mobile device 110 runs a mobile app. configured for use with child transportation system 100. Hub 103 and/or PCB 101 can communicate with the mobile app. via the system wireless connections. In one non-limiting example, hub 103 communicates wirelessly with mobile device 110 via a Bluetooth LE wireless protocol. However, it should be noted that system 100 is not limited in the protocol used for RF communication between various components of the system, and other known protocols may be used as well, such as ZigBee, any known version of IEEE 802.11, or other type of radio frequency protocol such as a proprietary frequency hopping spread spectrum protocol with a defined data format.

Mobile device 110 receives messages from hub 103 and may communicate messages back to system 100 through hub 103. A user interacts with the mobile app. that is configured to run on mobile device 110 to change settings of various child transportation system 100 attributes or to initiate, terminate or otherwise control actions within system 100.

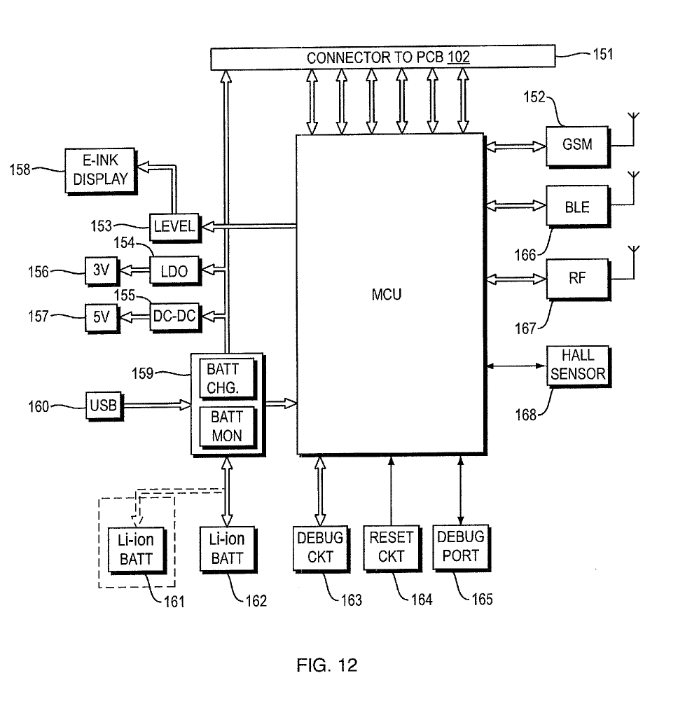

A user can initiate, for example, a calibration routine for hub 103 (which is described in more detail later). A user can initiate a pre-flight check of the system where various aspects of the system are checked prior to a vehicle initiating a trip. The pre-flight check is also described in more detail in a later section. The mobile device 110 can display, through the mobile app. to the user, the status of various system 100 attributes. For example, the status of the calibration routine can be displayed, or information required by the user to complete calibration steps may be displayed. Mobile device 110 can display, through the mobile app., the status of various system checks (whether checks are performed during the pre-flight check or during normal operation of the vehicle), where the status information is communicated by system 100 (typically via hub 103 though system 100 could also communicate with mobile device 110 via Bluetooth LE module 166 and/or GSM module 166 incorporated on PCB 101 and shown in FIG. 12. The status of each check performed by system 100 can be communicated, or the status of only failed checks can be communicated. Once a pre-flight check is completed, a pass/fail notification for the pre-flight check is communicated. Information regarding a possible safety issue can be communicated from system 100 to the app. running on mobile device 110, such as a harness or seat belt is not properly fastened, a seat is not secure or is not is the correct position, a dangerous environmental condition such as excessive temperature or high level of CO is present, an accident has occurred, or a child has been left behind. The app. can cause visual display of information, can cause the output of audible information such as an audible warning, or can cause tactile output such as vibration, or any combination thereof.

In one non-limiting example, some or all of the information communicated between the system 100 and the app. running on mobile device 110 may also be communicated to a user via a second user interface incorporated in another part of system 100. For example, calibration status and instructions as well as the results of system status checks and alarms can be communicated to a user via a user interface such as a display or audio output sub system incorporated as part of the seating component of the child transportation system 100, or as part of hub 103. The user interface may also include a control surface so information can be input to the system 100 via the control surface. This provides some redundancy, and also allows system information to be displayed and commands to be issued to the system when mobile device 110 is not present or is not running the mobile app. A control surface can include a button or buttons, a touch screen, or other known input device.

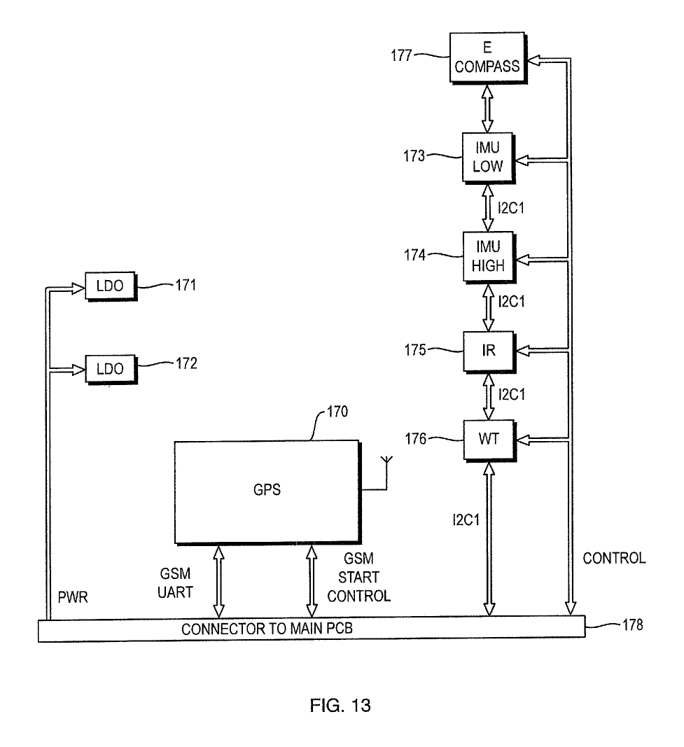

In one non-limiting example, a control surface is achieved by detecting touch or vibration of a portion of the child transportation system by vibration sensors such as accelerometers or IMU's incorporated in system 100. In one non-limiting example, a vibration sensor is included in a handle of a seating component of child transportation system 100. A tap or series of taps can be detected by vibration sensors and decoded into commands by a microcontroller or microprocessor that is in communication with the vibration sensor, such as microprocessor 150 of PCB 102, which is shown in FIG. 12. A pattern recognition operation can be run on the output of vibration sensors, such as IMU 173 of FIG. 13. The output from IMU 173 can be compared to stored patterns representative of a tap on a predefined area of the handle of a seating component of system 100. The handle of a seating component is a desirable location to use for registration of taps as it is a logical location for a user to “tap”, and in one non-limiting example, and IMU is located in the handle for other functions making it convenient to use it as a control input as well. When the IMU 173 output is determined to be a match with a stored “tap” pattern, a tap is registered by the microprocessor and a control operation associated with the tap can be executed. Using taps or vibration as a control input eliminates the need to add dedicated control hardware to system components. Any portion of system 100 that incorporates vibration sensors (such as a seating component 500 as shown in FIGS. 15A-C and/or hub 103) can use those vibration sensors as control input devices.

A control surface can also use sound input. A smart system such as the Alexa agent available from Amazon corporation, the Cortana agent available from Microsoft corporation, or the Siri agent available from Apple Computer, Inc., or other intelligent control agents may be used to control the child transportation system.

Hub 103 can communicate with mobile device 110 via Bluetooth LE, as previously mentioned. Bluetooth LE has an advantage that is operates over a limited distance. System 100 can determine whether or not mobile device 110 is within a certain distance of system 100 by monitoring whether or not a Bluetooth link exists between system 100 and mobile device 110. In certain instances, for example when it is determined that a child is present in a seating component of system 100 and the seating component is located within the vehicle, an alarm can be triggered if the mobile device moves away from the seating component location a sufficient distance such that the wireless link between system 100 and mobile device 110 is broken. The mobile app. which is configured to run on mobile device 110 may trigger an alarm (audible, visual, tactile, or combinations thereof) when the break in the wireless link is detected. Additionally, a component of system 100, such as hub 103 may also output an alarm, which may be audible, visual, or both when it detects that the wireless link has been broken.

The presence/absence of the communication link between the system 100 and the mobile device 110 could be monitored by mobile device 110, by a component of system 100 such as hub 103, or both. If only one end of the communication link is monitoring the presence/absence of the link, then a break in the link needs to be communicated to the other component to notify it to sound an alarm. In one non-limiting example, if hub 103 monitors the presence/absence of the wireless communication link, when the link is broken because the mobile device 110 has moved out of range, the hub 103 needs to communicate that information to mobile device 110. This can be done if a second wireless communication method is incorporated as part of system 100, such as GSM or GPRS. In one non-limiting example, child transportation system 100 communicates with mobile device 110 via more than one wireless link. In this example, once the Bluetooth link has been broken hub 103 communicates with mobile device 110 via the cellular network (via SMS text, voice, etc.) to trigger an alarm on mobile device 110. Simultaneously, hub 103 may also trigger an alarm.

The GSM/GPRS link through the cellular network may communicate with a mobile device that is not running the mobile app. Direct communication with the mobile device is possible, including via text message and/or a cellular voice call.

Depicted in FIG. 11 is a block diagram of one non-limiting example of a hub 103 for child transportation system 100. The power supply for hub 103 includes battery 140 and DC-DC converter 141. Hub 103 includes microprocessor 143 which interfaces to various elements of hub 103 and controls functions of hub 103. Hub 103 also includes low g IMU 144. Low g IMU 144 is used as part of a system that can determine the location and orientation of a seating component of the child transportation system 100 in a vehicle. By including such a device in hub 103, hub 103 can be used to provide a vehicle frame of reference, as will be described in more detail in a later section. High g IMU 145 is optionally included as part of hub 103.

An accident detection system can make use of high g IMU's (or accelerometers) located in various parts of system 100, such as high g IMU 174 of PCB 102 (shown in FIG. 13) which is incorporated into a seating component of system 100, and high g IMU 145 located within hub 103, if present, as shown in FIG. 11. An accident detection algorithm can be running on processor 150 of PCB 101 (which is in communication with IMU 174 via wired connection 151). If processor 150 determines that the acceleration sensed by IMU 174 exceeds a preset threshold acceleration representative of a minimum level of acceleration associated with an accident condition, processor 150 can trigger an alarm that an accident has occurred. The alarm may be audible, visual, or both. Processor 150 could communicate with various parts of the system to cause audible or visual outputs on different system components. If an audible or visual output device is present on PCB's 101 or 102, an output could be caused directly by processor 150. Alternatively, processor 150 could communicate via a wireless link to hub 103, key FOB 104, and/or mobile device 110 via proprietary RF, Bluetooth, or GSM wireless communication links, and audible and/or visual alarm outputs could be generated by audible/visual output subsystems incorporated on those system components. The alarm could cause buzzer 185 to output an audible signal. The alarm could cause LED array 189 to visibly output an alarm condition (such as by flashing red). The alarm could cause the hub 103 to display a visual warning of a problem that can be seen from outside the vehicle. The hub may also output an audible alarm. The alarm can be communicated to a key FOB. The key FOB may also output visual and audible signals indicating the alarm condition. Microprocessor 150 may also initiate communication with a remotely located device, such as a smartphone, tablet, personal computer and the like, sending a message to the remote device that a problem conditions exists.

If high g IMU 145 is present in hub 103, processor 143 of hub 103 may also run an accident detection algorithm. By including vibration sensors capable of withstanding high levels of acceleration in both the seating component and the hub components of system 100, accident detection reliability can be improved. When accident detection algorithms are running simultaneously on processor 143 of hub 103 and processor 150 of PCB 101 (which is in communication with IMU 174 via wired connection 151), their outputs can be compared before making a determination that an accident has occurred. Only if both algorithms determine an accident has occurred is an alarm condition triggered. This reduces the chances of false alarms arising from accidently hitting, dropping, or subjecting a seating component to a high g shock that is not caused by an accident condition.

Hub 103 also includes ecompass module 146. In one non-limiting example, Ecompass module is model LSM303AGR available from ST Microelectronics. Debug circuit 149 is used during development and for diagnosing problems with hardware/software. Reset 148 is used to reset the system if for some reason the hardware/software requires a re-boot. Wireless transceiver 147 provides an RF communication link between hub 103 and other system 100 components (FOB 104, seat main PCB 101, and/or PCB 107). Bluetooth LE module 142 provides a Bluetooth communication link with other system components, such as seat main PCB 101, mobile device 110, and key FOB 104 if desired.

Referring again to FIG. 9, circuit boards (PCB's) 105, 106 and 107 are shown. These PCB's share a wired connection providing power therebetween. PCB's 105 and 106 are simple and contain LED's for providing light, and may also incorporate simple mechanical pressure switches that are used as part of the system for checking seat belt routing. PCB's 105 and 106 are located on a seating component of the system at routing points for the vehicle seat belt. The LED's provide illumination for routing the seat belt at night or under low light conditions. LED's may also change color indicating improper (red) or proper (green) routing (though other colors may be chosen if desired). PCB PW3 107 includes additional functionality and will be described in more detail below.

Also shown in FIG. 9 are PCB's 101 and 102, which are both incorporated into a seating component of child transportation system 100. FIG. 12 depicts a block diagram of one non-limiting example of PCB 101, and FIG. 13 depicts a block diagram of one non-limiting example of PCB 102. PCB 101 and PCB 102 communicate with each other via a wired connection 108 sharing data and power, though a wireless connection could be used for data communication if desired for some reason. While certain functions are shown on one or the other board, examples are not limited to this particular configuration, and various functions could be arranged differently if desired. Functions could be split between more or fewer PCB's if desired for some reason. Examples disclosed herein are not limited in the particular split of functions between PCB's shown, or in the number of PCB's used to accomplish the function.

Referring now to FIG. 12, main PCB 101 includes microprocessor 150, which in this non-limiting example is a STM32L475RC processor available from ST Microelectronics. Microprocessor 150 controls the functions of the components located on a seating component of child transportation system 100, through peripherals located on PCB 101 and PCB 102. PCB 101 communicates with PCB 102 via wired interface 151. The power supply for PCB 101 includes battery 162 (and 161 if present), Battery controller 159 which includes battery charge and monitoring functions, and voltage regulators 154 and 155 providing required output voltages 156 and 157. USB connector 160 allows a standard USB connection to be used to charge battery 159 (and 161).

Though not shown in FIG. 12, alternative methods of charging the batteries are contemplated herein. In one non-limiting example, a wireless power transfer system, for example including the WiTricity WT8800-RB30 power transmitter and RB30-RX receiver, can be used to accomplish wireless charging where the RB30-RX receiver is located in the seating component of the system. Other wireless charging systems are also contemplated for use herein and examples are not limited to use of this particular wireless power transfer mechanism. The WT8800-RB30 power transmitter can be located in a seat base underneath the location of the power receiver in the seating component when the seating component is docked to the seat base, so wireless power transfer can occur. In one non-limiting example, the seat base could include a much larger battery that requires re-charging much less frequently than battery 159, where the large battery could wirelessly charge battery 159, or the seat base could alternatively be provided a connection to the vehicle power bus so that wireless charging of battery 159 can occur anytime the seating component is docked to the seat base installed in the vehicle. Incorporating wireless charging also allows the seating component to be easily recharged outside of the vehicle through a wireless charging mat.

Microprocessor 150 drives display 158 through level translation circuit 153, to provide a visual display for a user. In the example of FIG. 12, display 158 is an E-ink display which is useful because of its low power requirement, but other display types (such as LCD, OLED, etc.) can be used if desired. Also included are debug circuit 163 and debug port 165, which are useful during development or for diagnosing problems with system hardware. Reset circuit 164 may be a simple mech. switch used as a control interface for accepting input from a user. For example, a simple push of the button may initiate a complete reset of the system hardware/software. A press and hold could be used to accomplish a different function if desired.

GSM module 152 allows the PCB 101 to communicate with remotely located devices through the cellular network, via either SMS text or voice communication. This link allows the system to notify a 3^{rd} party of a safety or fault condition, or if an accident has occurred. Bluetooth LE module 166 allows the seating component of system 100 to communicate with another device via Bluetooth. In some instances, a hub may not be present (when a seat is used in a vehicle without a hub). In this instance, the seat can still communicate with a user via an app running on the user's mobile phone, where communication between the seat and the app. is via Bluetooth LE. RF module 167 communicates with FOB 104 via an RF protocol, though as mentioned previously the system is not limited in the wireless communication methods used for the FOB and seat to communicate with each other. RF module 167 could also communicate with RF module 147 of hub 103 if desired, though this communication is more likely done via Bluetooth LE modules 166 and a Bluetooth module 142 of hub 103. Hall sensor 168 is used to determine when a handle of a seating component of system 100 is positioned in a predetermined position, such as a driving position.

Referring to FIG. 15A, hall sensor 168 which is located on PCB 101 is used to determine when the handle 195 of seat 500 is in a driving position as shown in dotted lines in FIGS. 15A and 15B (having a handle reference position for driving aides in other system functions, as will be described in more detail later). Main 101 is located in handle 195 near pivot point 196 of handle 195. Hall sensor 168 can be located on PCB 101 and a magnet 197 can be located in basket 198 of seating component 500 such that the hall sensor 168 gives a high output when the handle is in its driving position. Alternatively, optical or mechanical switches could be used to determine when the handle is in a predetermined position, and systems disclosed herein are not limited in the manner by which they sense handle position.

FIG. 13 depicts a block diagram for one non-limiting example of PCB 102. PCB 102 shares a wired connection with PCB 101 through connector 178. GPS circuit 170 provides GPS information to system 100. In one non-limiting example, GPS information received from GPS circuit 170 is communicated to a remotely located device by system 100 when an accident or alert condition is detected. Information describing the location of the vehicle in which child transportation system is located is relayed to the remotely located device, along with information about the condition that triggered the alert (i.e. a child is left behind, an over temp, condition is detected and a child is present, an accident has occurred, or other alert condition). The GPS information is transferred to processor 150 which provides the information to the remote device via GSM module 152.

Also included on PCB 102 are low and high IMU modules 173 and 174, IR sensor 175, weight sensor 176, and voltage regulators 171 and 172. IMU low module 173 is used as part of a system to determine location and orientation of a seating component of system 100 within a vehicle, and will be described in more detail later. IMU high module 174 is used to monitor higher level linear and rotational accelerations that can occur in an accident. IMU's incorporate 3 axis accelerometers for sensing linear acceleration and one or more gyroscopes for sensing rotational acceleration. The output of IMU 174 is provided to processor 150. As part of an accident detection routine running on processor 150, either linear acceleration or linear and rotational acceleration levels are compared to predetermined thresholds associated with accident conditions. When the predetermined thresholds are exceeded, and alarm is triggered. System 100 can determine if a crash or rollover events has occurred depending on whether linear acceleration or rotational acceleration thresholds have been exceeded. Information regarding the nature of the accident (crash, rollover, or both) can also be relayed to a 3^{rd} party located remotely from the vehicle, as previously described. Voltage regulators 171 and 172 output system power supply voltages that are used by electrical components located on PCB 102.

Accident monitoring can include a mobile app that runs on mobile device 110 and is configured to communicate with the system described above. The mobile device 110 may have (and often will have) motion sensors such as one or more accelerometers and one or more rotation sensors, and will always include a processor. In this case, then, the mobile device 110 can run the same crash detection algorithm as the car seat, using the mobile device's own motion data. Using APIs, the mobile device 110 can communicate with other driving-related apps (such as Android Auto and various GPS navigation apps), to determine when the user of the mobile device 110 is driving. In this case, the mobile device app can communicate with the child transportation system accident detection system. In the case of an accident as determined by the mobile device app, a comparison can be made to the data from the mobile device 110 and the conclusions reached by the child transportation system concerning an accident. This allows the mobile device 110 to effectively verify the accident conclusion made by the child transportation system, which can improve the accuracy of the notifications sent out by the child transportation system. Also, the mobile device app can allow the user to dismiss an accident notification if the recipient is sitting in the motor vehicle and receives an accident notification, but no accident has occurred.

Weight sensor 176 can include one or more pressure or force sensors, or any other type of sensor from which weight can be determined. The sensor(s) data can be converted into a variable physical quantity of force, namely, weight. Pressure sensors can be piezo-resistive pressure sensors or other types of now-known or future-developed pressure sensors. When a force sensor is used, it can be a load cell, or any other type of now-known or future-developed force sensor. In one specific, non-limiting example, the weight sensor 176 is arranged in the middle of the seating component handle 195. When the seating component is lifted by the basket handle 195, the weight sensor 176 detects the force, which can then be converted to weight by a processor. The weight data can then be input to a weight processing control module for further processing.

Weight measurements can be made over time and averaged to improve reliability of a child's weight estimate. Weight data can be compared to stored recommended weights for the particular seating component, as described in later sections. Use of averaged data improves the accuracy and reliability of the weight check processes described later. It should be noted that unlike systems where a weight sensor is used for a simple go/no-go check of whether or not a child is present in a seating component, weight sensor 176 is used to accurately estimate the child's weight for comparison to stored recommended weights limits for the seating components. Placing sensor 176 in the handle allows the entire weight of the child (plus seat) to be measured, and averaging measurements over time allows disturbances such as vibration while walking and holding the seating component to be rejected from the measurement.

A history of weight data can also be used to predict what a child's weight will likely be at a date in the future. The ability to predict future weight increases can allow the system to inform the user that their child will likely exceed the recommended weight for this particular seat within a certain period of time, giving the user advance notice that they will need to obtain a new seating component soon.

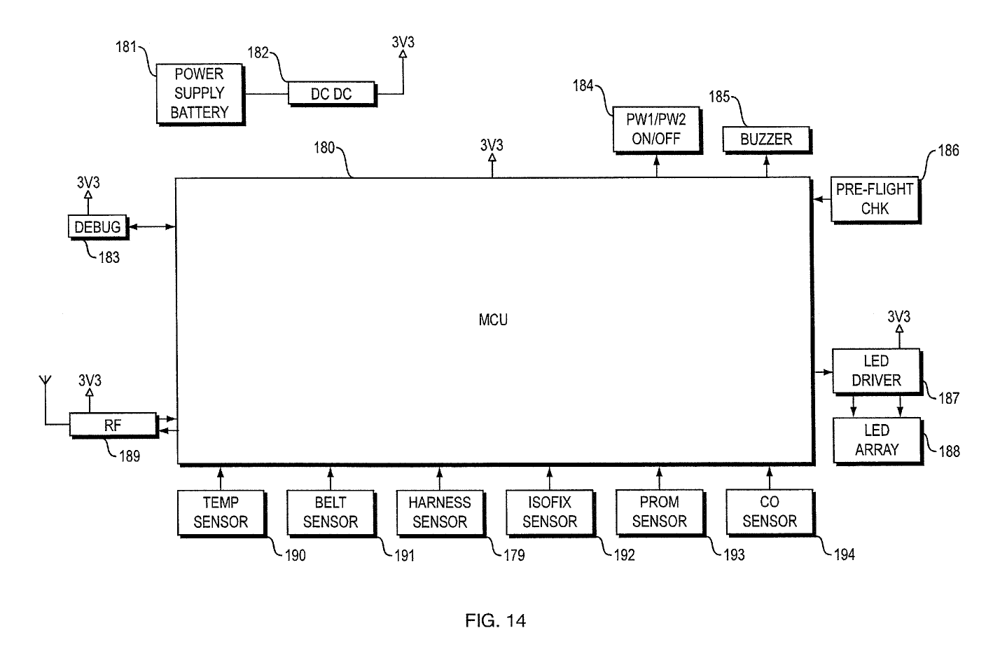

A block diagram of one non-limiting example of PCB 107 is depicted in FIG. 14. PCB 107 includes microprocessor 180 which controls functioning of PCB 107. The power supply of PCB 107 includes battery 181 and DC-DC converter 182. Microprocessor 180 includes I/O interface 184 which is used to control power applied to PCB's 105 and 106. I/O interface 184 is used to control the light output of LED's included on PCB's 105 and 106, to provide light when necessary. In one non-limiting example, when a button is pressed on a seating component of the system or on an associated key FOB, microprocessor 180 can cause LED's on PCB's 105 and 106 to light so that a user can see where to route the vehicle seat belt through the seating component. Alternatively, in one non-limiting example vibration of handle 195 (shown in FIGS. 15A-C) is sensed by IMU 173 on PCB 102 which is also located in handle 195. The sensed vibration signal from IMU 173 is communicated to processor 150 via a wired connection. Processor 150 analyzes the IMU 173 output and determines if a double tap event has occurred (if a user has tapped on the handle twice, which is used as a control input for the system). Alternatively, the IMU 173 output signal could be wirelessly communicated to processor 180 if desired and processor 180 could perform the analysis to identify a double tap. This would require a continuous RF link whereas having processor 150 perform the analysis means only an interrupt needs to be communicated to processor 180 over the RF link. Once microprocessor 150 has determined a double tap event has occurred, processor 150 sends an interrupt request to processor 180 via RF modules 167 and 189 to toggle lights located on PCB's 105 and 106, and also 107, if desired, via I/O port 184.

Detection of a second double tap and communication of a second interrupt request to processor 180 can toggle the lights on PCB's 105, 106, and 107 via I/O port 184 back to their original state. Alternatively, a timer may be initiated to run internal to microprocessor 150 or microprocessor 180 upon the initial double tap detection (or initial toggle event). When the timer reaches a predetermined time period, microprocessor 150 can send an interrupt to processor 180 to toggle power to the lights (or processor 180 can directly toggle power to the LED's back to their original state if the timer was running on processor 180).

Microprocessor 180 can also control buzzer 185. It should be noted that rather than a buzzer, any device capable of causing an audible output could be controlled by microprocessor 180. The audible output is used to alert the user of a potential problem in the system, whether with the installation of the seat or with the environment in which the seat is located, or with the hardware itself. The provision of feedback to the user is described in more detail in the section describing the pre-flight check.

In one non-limiting example, a pre-flight check routine can be initiated by a user by actuating a control surface coupled to I/O port 186. When microprocessor 180 detects that a control connected to I/O port 186 has been actuated, the pre-flight check routine is initiated. A simple press of a push button control surface can initiate the pre-flight check. Additionally, if desired, a press and hold operation can be used to initiate a pairing operation for the seat in which PCB 107 is located with other system components (hub 103, FOB 104, or the user's mobile device 110). It should also be noted that more than one control surface incorporated in system 100 could be used to initiate the pre-flight check or the pairing operation. For example, a button press and hold on key FOB 104 or taking an action within the mobile app. that runs on user's mobile device 110 could also initiate a pre-flight check.

Microprocessor 180 controls LED array 188 through LED driver 187. LED array 188 is used to provide visual information to the user. LED array 188 could use multi-color LED's and the color displayed can be correlated with various states of the system. Alternatively, LED array 188 can be arranged to output alphanumeric information to a user. Though an LED array is shown, other types of displays are contemplated for use with the systems disclosed herein. For example, an LCD or OLED display capable of providing a graphic visual output could be used if desired. Any known display type is contemplated for use herein.

Microprocessor 180 interfaces with various sensors and switches. Microprocessor 180 is in communication with temperature sensor 190, belt sensors 191, seating component harness sensor 179, Isofix sensors 192, proximity sensors 193, and carbon monoxide (CO) sensors 194. Temperature sensor 190 is located on PCB 107, and is used to detect ambient temperature in the area where a seating component of a child transportation device is located. One location for PCB 107 is shown in FIG. 15B, where PCB 107 is located on the rear of a basket portion of a seating component, but other locations on the seating component for the temperature sensor 190 are also contemplated. The temperature sensor can be a thermistor, a thermocouple, or other known type pf temperature sensor. In one non-limiting example, the temperature sensor is a TMPO6 temperature sensor, available from Analog Devices, Inc. of Norwood, Mass., USA. The temperature sensor can have a cover that keeps direct sunlight from reaching the sensor, and the cover has openings allowing airflow around the sensor. Though not shown, a second temperature sensor can be incorporated into hub 103. This can be used to monitor the vehicle environment when a seating component is not present, which may be of use in monitoring conditions for pets.

Microprocessor 180 obtains information on ambient temperature from sensor 190. In one non-limiting example, the sensed temperature is compared to one or more predetermined temperature thresholds. Microprocessor 180 can cause an alarm to be triggered if the sensed temperature exceeds a predetermined threshold. When the detected temperature exceeds a predetermined threshold temperature, the microprocessor triggers an alarm, which can be audible, visual, or both. The alarm can cause buzzer 185 to output an audible signal. The alarm can cause LED array 188 to visibly output an alarm condition (such as by flashing red). The alarm trigger can be communicated to other portions of the system. For example, the alarm trigger could be communicated to hub 103 and hub 103 may display a visual warning of a problem that can be seen from outside the vehicle. Hub 103 may also output an audible alarm. The alarm trigger can be communicated to key FOB 104. Key FOB 104 can output visual and audible signals indicating the alarm condition. Microprocessor 180 can also initiate communication with remotely located mobile device 110 (such as a smartphone, tablet, personal computer and the like) sending a message to remote mobile device 110 that a problem conditions exists. Processor 180 can alert a user of remote mobile device 110 through a mobile app., and can also describe the condition to the user (for example, that a dangerous temperature is present and also display the temperature). Processor 180 communicates with mobile device 110 via a GSM module incorporated as part of child transportation system 100. For example, processor 180 can communicate with processor 150 of PCB 101 via RF modules 189 and 167, and processor 150 can then communicate with a mobile device via GSM module 152. In one non-limiting example, system 100 can display the ambient temperature using LED array 188 configured to output alphanumeric information.

Seat belt sensors 191 are located proximate to vehicle seat belt routing structures 199A, 199B, 199C, and 199D incorporated as part of seating basket 198, as shown in FIGS.

15A, 15B and 15C. Sensors 191 are connected via wired connections to PCB's 105, 106 and 107, where sensors 191 connected to PCB's 105 and 106 are then also connected via a wired connection to PCB 107. Seat belt routing structures 199A and 199D are located on the sides of seating basket 198 and are arranged to accommodate the lap belt portion of the vehicle seat belt. Seat belt routing structures 199B and 199C are located on the rear of seating basket 198, and are arranged to accommodate the shoulder portion of the vehicle seat belt. A pair of routing locations 199B and 199C are used to accommodate the shoulder belt portion of a vehicle seat belt in order to accommodate placement of the seating component in either a left or right-side vehicle seat.

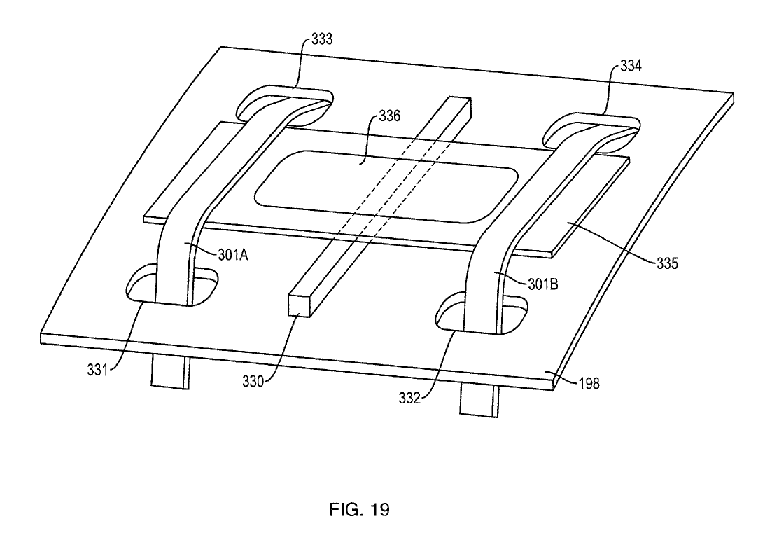

One non-limiting example of vehicle seat belt routing structure is shown in FIG. 18. FIG. 18 is an enlarged view of seat belt routing location 199D of FIG. 15B. Vehicle seat belt 301 routes through slot 303. Slot 303 is formed between a portion of seating basket 198 and tang 302 which is part of seat belt routing point 199B and sits proud of the surface of seating basket 198. When seat belt 301 is properly routed through slot 303 and secured in place such that the belt is properly and securely tensioned, mechanical switch 305 which functions as a belt routing sensor 191 is actuated by the belt, such that the switch is closed. Switch 305 is arranged such that simply passing the seat belt 301 through slot 303 is not sufficient to actuate switch 305. Belt 301 must be tensioned such that it exerts a force against the outer surface of seating basket 198 before switch 305 closes. The mechanical properties of switch 305 can be chosen such that switch 305 only closes if sufficient belt tension is applied to ensure the seating component is properly secured. Switch 305 is wired to PCB 106 which is located under cover 306 of routing location 199B, and is further connected to PCB 107 through a separate wired connection. Processor 180 (shown on FIG. 14) monitors the various belt sensors 191, such as switch 305, and when a correct number of switches are closed, processor 180 determines that the vehicle seat belt is properly routed. Though an enlarged view of shoulder belt routing locations 199B and 199C is not shown, they operate similarly to location 199B shown in FIG. 18, where the shoulder belt must be both properly routed and sufficiently tensioned in order to close mechanical switches used as routing sensors 191.

Isofix sensors 192 detect whether or not a seating portion of a system is connected to an Isofix child safety seat base. In one non-limiting example, sensor 192 is a momentary contact switch located on a bottom surface of seating component 500. The momentary contact switch is located in a position on the bottom of seating component 500 such that the switch will be closed if the seat is fit into an Isofix base, but will not be closed if seating component rests directly on a vehicle seating surface.

Though not currently shown, an Isofix connector sensor can also be used to detect whether or not an Isofix base is properly locked into the vehicle seat connectors. Existing Isofix seat bases have a mechanical display that can switch from red to green when the Isofix base is properly installed in the vehicle. In one non-limiting example, an electrical sensor is coupled to the mechanical indicator. When the mechanical indicator indicates the Isofix base is properly installed, the electrical switch is closed and a signal can be sent to child transportation system 100 that the Isofix base is present and Isofix connectors are properly locked in place. The Isofix connector sensor described above is used as part of the Isofix connector condition check described in subsequent sections.

Proximity sensor 193 is used as an occupancy sensor to detect if the seating component of a system is occupied by a child. In one non-limiting example, capacitive sensor

CY8CMBR3102 available from Cypress Semiconductor is configured as a proximity sensor for use as a seating component occupancy sensor. The CY8CMBR3102 IC has a pair of sensor inputs. Both inputs are used, where a sense wire is connected to each input. The sense wires on one end connects to the capacitive sensor IC on PCB 107. The wires run underneath the area where the child will rest in the seating component. The wires are unshielded in the region where they are running under the child, and are shielded elsewhere. The wires are run as close to the child as possible to increase sensor sensitivity. In one non-limiting example, the wires are run along the inner surface of a child seating component basket, underneath the child. The wires can be run in a channel so that they are slightly recessed from the surface of the seating basket facing the child to reduce chances of the wires becoming damaged. In one non-limiting example, the wires are run on the underneath side of the seating component basket such that the wall of the basket sits between the wires and the child. This arrangement further protects the wires from damage, but reduces sensitivity of the occupancy detection. In this example, in the region where the wires run, the wall of the seating basket can be reduced in thickness to reduce the sensitivity loss. The region of the seating basket wall directly above the wires may have holes added to further reduce the sensitivity loss from having plastic material between the sense wires and the object to be sensed (i.e. the child). A pair of wires (as opposed to using a single wire) are used to increase sensitivity and robustness of the occupancy sensor. The signal output of the capacitive sensor is averaged and compared to a predetermined threshold value. The seating component is determined to be occupied by a child when the sensed value exceeds the predetermined threshold value.

In one non-limiting example, rather than using a capacitance based sensing technique to determine occupancy of the seating component, other methods such as optical (IR), ultrasonic, imaging, motion, and pressure sensing are also contemplated herein. Capacitive sensing has an advantage in that it is less easily fooled when an object that is not a child occupies the seating component and it has low power requirements compared to other sense methods, but other methods can be employed to accomplish occupancy detection. It is also possible to combine methods to further improve robustness of the detection.

In one non-limiting example, the child transportation system 100 incorporates an ability to determine if the vehicle in which the system is installed is occupied by a pet. A pet can wear an identification tag (such as an RFID or BLE based tag) on a collar that can be read by hardware incorporated into system 100. A BLE based tag can use the same Bluetooth hardware already included in system 100 for other purposes, as described earlier. The system is designed such that anytime the pet BLE tag is within range of the system (for example, in range of hub 103), the pet tag automatically pairs with a Bluetooth module of system 100, and the system determines that the pet is occupying the vehicle. System 100 can then provide alerts to the user or 3rd parties in a similar manner to what was described earlier if a pet is left behind, if the environment (temperature, carbon monoxide) become dangerous, etc.

CO sensors 194 are used to detect the level of CO present in the ambient environment. Microprocessor 180 is in communication with CO sensor(s) 194. Microprocessor 180 compares the detected CO level with one or more pre-determined threshold levels. When the detected level exceeds a predetermined threshold level, the microprocessor triggers an alarm, which may be audible, visual, or both. The alarm could cause buzzer 185 to output an audible signal. The alarm could also cause LED array 188 to visibly output an alarm condition (such as by flashing red). The alarm trigger can also be communicated to other portions of the system. For example, the alarm trigger could be communicated to hub 103 and hub 103 may display a visual warning of a problem that can be seen from outside the vehicle. Hub 103 may also output an audible alarm. The alarm trigger can be communicated to key FOB 104. Key FOB 104 can output visual and audible signals indicating the alarm condition in response to receiving the alarm trigger. Microprocessor 180 can also initiate communication with remotely located mobile device 110 (such as a smartphone, tablet, personal computer and the like) sending a message to remote mobile device 110 that a problem conditions exists. Processor 180 can alert a user of remote mobile device 110 through a mobile app., and may also describe the condition to the user (for example, that a dangerous level of CO is present). Processor 180 communicates with mobile device 110 via a GSM module incorporated as part of child transportation system 100. For example, processor 180 can communicate with processor 150 of PCB 101 via RF modules 189 and 167, and processor 150 can then communicate with a mobile device via GSM module 152. If a communication link has been established with the vehicle, commands can be sent to the vehicle to actuate vehicle subsystems when a dangerous level of CO is present. Commands could be issued to open vehicle windows, to command the HVAC system to provide fresh air, or even to shut off an engine if the vehicle is not moving and the transmission is in park.

One non-limiting example of harness sensor 179 is shown in FIG. 19. FIG. 19 depicts a section of the back side of seating basket 198. Holes 331, 332, 333, and 334 allow the seating component harness 301A and 301B to fit through the holes and loop around substrate 335. Substrate 335 is pivotably coupled to rib 330 such that the center of substrate 335 is coupled to rib 330, and substrate 335 sits above the surface of seating basket 198.

When harness belts 301A and 301B are equally tensioned, substrate 335 bends on either side of rib 330. Mounted to substrate 335 is strain gauge 336. When substrate 335 is bent, a signal is generated in strain gauge 336. The output of strain gauge 336 is compared to a predetermined threshold signal. When the output of strain gauge 336 exceeds the predetermined threshold, a sufficient amount of tension has been applied to the harness.

In one non-limiting example, a second predetermined threshold exists, higher than the first threshold. This threshold represents a maximum allowable tension. If a level of tension is applied that causes the strain gauge output to exceed this second, maximum threshold level, system 100 will notify the user that improper tension has been applied. This could be done by actuating buzzer 185, LED array 188, or other portions of system 100 that can communicate to a user. For example, PCB 107 can communicate with hub 103 and hub 103 can communicate with remote mobile device 110 through the mobile app. Alternatively, processor 180 on PCB 107 could cause lights on PCB 105, 106 and 107 to flash when the harness is improperly tensioned. Systems disclosed herein are not limited in the manner in which they can be notified of improper tension in the seating component harness.

If an imbalance in tension is applied between belts 301A and 301B, substrate 330 will pivot about rib 330, rather than bend around it. Because the substrate does not bend, or bends less, the strain gauge output is lower and may not exceed the predetermined threshold. This is desirable as a condition where one belt is tight while a second belt of a child harness is loose is an undesirable condition, and the system should not indicate proper tension when such an imbalance is present.

In one non-limiting example, rather than using a single, cantilevered harness tension sensor as shown in FIG. 19, a pair of sensors could be used, one for belt 301A and a second for 301B. The structure of FIG. 19 could easily be adapted to accomplish this. Rather that pivotably coupling substrate 335 to rib 330, substrate 335 can be rigidly fixed to rib 330, and single strain gauge 336 is replaced by a pair of strain gauges located to either side of rib 330. Each strain gauge will then be responsive to the tension in the belt it is proximate to. Processor 180 can monitor the output of the pair of strain gauges to make sure both outputs are in the desired range of operation.

In one non-limiting example, a stretch sensor can be attached to each shoulder strap in the seating component harness. Stretch sensors are known, one example of which is the “Fabric Stretch Sensor” available from StretchSense, located in Auckland, New Zealand.

Child transportation systems disclosed herein perform various operations before, during, and after a vehicle trip has occurred. Prior to a trip, a child transportation system can perform a pre-flight check ensure that a proper seating component is being used (that the child size and weight do not exceed size and weight limits for the seat), that the seating component is properly and safely installed in the vehicle, that the child is properly secured in the seating component, and that all child transportation system components are functioning properly. Once the pre-flight check is complete, during the trip the child transportation system can monitor itself to ensure all components continue to function properly, the child remains properly secured in the seat, and the seat remains properly secured in the vehicle. After the trip is complete, the child transportation system monitors the vehicle to ensure a child (or pet) is not left behind and dangerous conditions are not present.

Before the child transportation system operation discussed above is fully described, one additional aspect of system operation not earlier discussed will be described detail. As part of both the pre-flight check and continuing operational checks, the child transportation system monitors whether or not the child seat is properly oriented within the vehicle. In order to accomplish this, the system must be able to determine orientation of the seating component in the vehicle, in the vehicle frame of reference. Knowing the seat orientation in an earth frame of reference is not sufficient because the vehicle orientation with respect to gravity can change (when a vehicle is on a hill, for example). The system must be able to determine the orientation of the seating component within the vehicle frame of reference in order to determine if the seating component is properly oriented within the vehicle. In order to accomplish this, a component of the system, other than the seating component, must provide the vehicle frame of reference information.

As described previously, child transportation system 100 includes hub 103. Hub 103 is affixed to the rear window of the vehicle. Hub 103 includes low g IMU 144, which provides 3 axis accelerometers and 3 degree of freedom gyroscopes, and ecompass module 146, which provides 3 axis magnetometers also used for obtaining orientation information. Such sensors of providing orientation information are referred to as orientation sensors. In one non-limiting example, low g IMU 144 is model LSM6DS3 from ST Microelectronics, and ecompass module 146 is model LSM303AGR 3 axis magnetometer and 3 axis accelerometers, also available from ST Microelectronics.

In order to determine the child transportation system seating component orientation with respect to the vehicle, a calibration process must first be performed. The steps of the calibration process are given below. The orientation sensors incorporated on hub 103 (low g IMU 144 and ecompass 146) are used to perform this calibration. Methods for using IMU's and magnetometers to calculate orientation of a body are known in the art. In one non-limiting example, orientation of the hub 103 with respect to earth and the vehicle with respect to earth are determined using the Madgwick algorithm available here: http://x-io.co.uk/open-source-imu-and-ahrs-algorithms/. The algorithm is described in the original report document here: http://x-io.co.uk/res/doc/madgwick_internal_report.pdf, which is herein incorporated by reference in its entirety, and also in: “Estimation of IMU and MARG orientation using a gradient descent algorithm”, by Sebastian O. H. Madgwick, Andrew J. L. Harrison, and Ravi Vaidy Anathan, presented at the IEEE International Conference on Rehabilitation Robotics Rehab Week Zurich, ETH Zurich Science City, Switzerland, Jun. 29-Jul. 1, 2011, which is also herein incorporated by reference in its entirety.

The calibration operation is performed when the child transportation system is first installed in the vehicle. Calibration need not be performed again unless hub 103 is replaced or moved, or if data becomes corrupted for some reason. The calibration can be performed by a user by following a set of steps that are provided as written instructions included with the child transportation system, or a mobile app. can prompt a user as needed to perform the calibration operations.

In one non-limiting example, a mobile app. running on a remote mobile device such as mobile device 110 is incorporated as part of the calibration process. The mobile app. can provide feedback to the user leading the user through the various steps of the calibration process, and can receive feedback from other system components identifying when steps have been completed. In order for the mobile app. to aide in the calibration process, mobile device 110 on which the app. is running needs to be paired with hub 103. Once the app. is initiated a user will be prompted during system setup to initiate the calibration process. The mobile app. will then step through the calibration process guiding the user actions and receiving feedback from system components when actions are complete.

The calibration process steps are given below:

Note: Prior to making measurements, the system may perform a self-check to ensure the hardware is working properly. Additionally, the system may query motion sensors (such as IMU 144) to determine if any system components are in motion, and may suspend further measurements until any error conditions are addressed or the component motion ceases.

1. Obtain vehicle's orientation with respect to Earth.

$${ }_{Earth}^{car} q \qquad ( 1 )$$

In order to determine the orientation quaternion of the vehicle with respect to earth, orientation sensors linked to the vehicle must be used. In one non-limiting example, a mobile computing device having the requisite orientation sensors, such as mobile device 110, is placed on the seat of the vehicle in the intended location of the seating component of the child transportation system (typically a rear seat but the process could be used for front seat location if desired). The mobile device must be placed on the vehicle seat in a predetermined orientation, where the alignment of the mobile device with respect to the forward axis (x axis) of the vehicle is known. Once the device is properly placed in the vehicle, data is acquired from the mobile device's onboard sensors. In one non-limiting example, rather than placing a mobile computing device on the vehicle rear seat, the hub 103 can be placed on the vehicle seat and the onboard sensors of hub 103 can be used. Use of the mobile device provides the additional benefit of being able to provide rich feedback to the user via the typically more complex user interface available in mobile devices. In one non-limiting example, IMU's and magnetometers that exist within a vehicle can also be used. For example, sensors built into embedded GPS systems, or embedded stability control or other systems in a vehicle could be used to provide a vehicle location reference. However, using these systems requires coordination with vehicle manufacturers to allow an external system such as a child transportation system to access the vehicle's embedded sensors, and requires prior knowledge of the orientation of these sensors.

An acquisition of data from the orientation sensors of the device placed on the vehicle seat as described above is performed, and the orientation quaternion of the device with respect to earth is obtained. Since the device was placed in a known relationship to the vehicle, this data also reflects the orientation of the vehicle with respect to earth. This information is part of the calibration data and is stored for later use.

2. Measure HUB's orientation with respect to the Earth.

$${}_{Earth}^{hub} q \qquad ( 2 )$$

Prior to determining the hub's orientation with respect to the Earth, the hub is mounted to the rear window of the vehicle as previously described. Data is acquired from the hub's onboard sensors and its orientation quaternion with respect to the Earth is calculated. This information is also part of the calibration data and is stored for later use.

Steps 1 and 2 provide the vehicle and hub orientation quaternions with respect to Earth, which is one referent system which is the same in both cases. Steps 1 and 2 above provide calibration data which is stored for later use.

The next section describes one process for determining the orientation of a seating component with respect to the vehicle, based on the calibration data obtained above, a subsequent (new) measurement of the hub (mounted) orientation with respect to earth, and a measurement of the seating component orientation with respect to the earth. However, it should be noted that there are various mathematically equivalent ways one can obtain the seating component orientation with respect to the vehicle based on the above measurements, and examples disclosed herein are not limited in the one particular set of steps described. For example, in one process the calibration data can be used to obtain a relationship between the car and the hub, using the compound quaternion operation described below, and this result can then be used in later calculations. Alternatively, as described below, this explicit relationship need not be directly calculated.

Equation 3. Below is the compound quaternion operation, (which is Equation No. 3 from Madgwicks internal report referenced above

$${}_{C}^{A} \hat{q} = {}_{C}^{B} \hat{q} ⊗ {}_{B}^{A} \hat{q} \qquad ( 3 )$$

Madgwick's equation No. 3 states that any relative orientation between two objects can be calculated if their orientation to some third object (which in this case is Earth, letter B in his equation 3) is known. The compound quaternion is used a number of times to transform the calibration and measurement data into the final result as follows.

Once the calibration has completed, seat orientation with respect to the vehicle can be determined as follows. The seating component is placed in the vehicle and secured in place using the vehicle seat belts. The seating component handle is placed in its reference driving position (the reference driving position is described elsewhere in this disclosure). Since in some examples the seating component handle houses orientation sensors (IMU's and magnetometers), placing the handle in a reference position locks the position of the sensors into a known position. A new measurement of the hub (mounted) orientation quaternion with respect to earth is performed:

$${}_{Earth}^{hub new} q \qquad ( 4 )$$

A new measurement is made because it is likely the vehicle has moved from the time the calibration measurements were made. We assume that the car has moved from the position in which we have performed calibration. Since this would have changed the hub orientation with respect to earth compared to what was measured during calibration, a new measurement of the hub orientation with respect to earth is made.

A new measurement of the seat orientation quaternion with respect to earth is made.

$${}_{Earth}^{seat new} q \qquad ( 5 )$$

The seating component orientation sensors located inside the handle are used to collect data. The relationship between the sensor axes and the seating component structure is known because the orientation of the orientation sensors within the seating component is determined during manufacture, and a specific arrangement is known when the handle is in its reference position

A correction factor quaternion for the hub is calculated by applying the compound quaternion operation of eq. 3 to the previous measured quaternion of the hub with respect to earth and the new measured quaternion of the hub with respect to earth.

$${}_{hub}^{hub new} q = {( {}_{Earth}^{hub} q )}^{*} ⊗ {}_{Earth}^{hub new} q \qquad ( 6 )$$

Which can be also written as:

$${}_{hub}^{hub new} q = {}_{hub}^{Earth} q ⊗ {}_{Earth}^{hub new} q \qquad ( 7 )$$

Where the operator * is called a conjugate operator described below:

$${}_{A}^{B} q = {( {}_{B}^{A} q )}^{*} \qquad ( 8 )$$

It is assumed that the HUBS position in the vehicle has not changed between these measurements. Therefore, whatever amount the HUB had changed his orientation from its orientation during calibration to its orientation at the present time is the same amount that the vehicle orientation has changed between the two measurements. Therefore, the following relationship applies:

$${}_{hub}^{hub new} q = {}_{car}^{car new} q$$

Finally, we can determine the new seating component orientation quaternion with respect to the new car orientation by applying another compound quaternion operation:

$${}_{car new}^{seat new} q = {( {}_{Earth}^{car new} q )}^{*} ⊗ {}_{Earth}^{seat new} q ,$$

Which can be re-written as:

$${}_{car new}^{seat new} q = {}_{car new}^{Earth} q ⊗ {}_{Earth}^{seat new} q$$

The above measurements and calculation of a new seating component orientation with respect to the vehicle is the operation performed when a “seat orientation” check, as described elsewhere in this disclosure, is performed. The seating component orientation with respect to the vehicle determined above is compared to a predetermined orientation stored in system memory. In one non-limiting example, a difference between the measured orientation and the stored orientation is compared to a predetermined threshold difference.

In one non-limiting example, the inclination angle of the seating component is compared to a stored inclination angle. A predetermined difference threshold of 5 degrees may be used so that inclination differences greater than 5 degrees from the stored value are determined to be unacceptable. It should be noted that although a threshold of 5 degrees is disclosed above, a different threshold could be set if desired, of for example, 8 degrees, 10 degrees, or any threshold a manufacturer determines still falls within the range of proper installation specifications.

In one non-limiting example, the orientation of the x axis of the seating component in the vehicle is compared to vehicle x axis (which is the axis aligned with the vehicle direction of motion). If the angular difference between the seating component x axis and the vehicle x axis differs by more than the predetermined threshold, the seating component orientation is determined to be incorrect and feedback is given to the user to correct the orientation. If the angular difference between the seating component x axis and the vehicle x axis differs by less than the predetermined threshold, the seating component orientation is determined to be correct.

Various “checks” are performed as part of a system checks, where a system check may be a pre-flight check undertaken before a trip commences, an automatic system check that is initiated by the system once a trip has begun, if a pre-flight check has not been performed, or an ongoing system check performed during operation of the system. Various system checks are described in more detail later in this disclosure.

As mentioned earlier, child transportation system 100 is functional before, during, and after a vehicle trip. Before a vehicle trip is undertaken, the system can perform a pre-flight check. In one non-limiting example, a user can initiate a pre-flight check by actuating a control surface of system 100. A user can initiate pre-flight check by pressing a button on key FOB 104, by pressing a button located on the seating component 500 of the system which can be connected to pre-flight I/O 186 on PCB 107, or by actuating a command on a mobile app. running on mobile device 110. In order to initiate pre-flight check via key FOB 104 or the mobile app., a connection must already exist between FOB 104 and hub 103, or between the mobile app. running on mobile device 110 and hub 103. A connection to hub 103 is not required if a button is pressed on the seating component, as the seating component can initiate a pre-flight check, even if hub 103 is not present (though some functional checks that require hub 103 will not be performed).

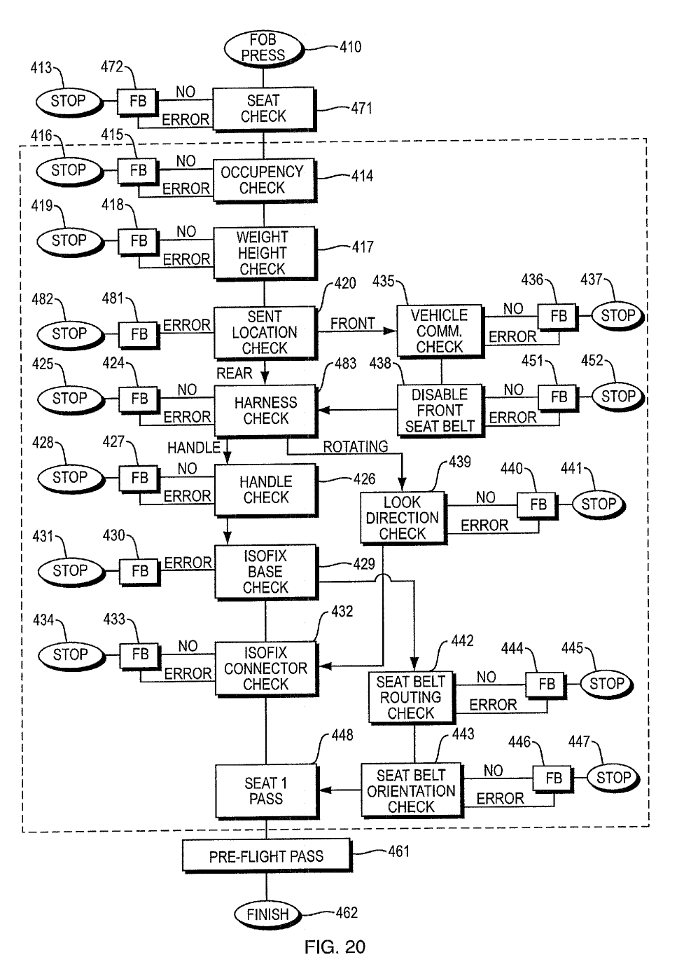

When button 340 on key FOB 104 is pressed, momentary switch 341 on PCB 205 (see FIG. 16) is actuated and pre-flight check is initiated. FIG. 20 depicts one non-limiting example of a flow chart for pre-flight check when a key FOB button is pressed. This same flow chart applies if a command on the mobile app. is actuated. A slightly different flow chart is applicable when a button on seating component 500 is pressed which will be described in more detail shortly.

Turning to FIG. 20, the pre-flight check starts when a key FOB button press 410 is detected (or a command is actuated on the mobile app running on mobile device 110). The system next performs seat condition check 471. The system checks for the presence of communication links between the hub 103 and seating components. Based on the number of links identified, the system 100 can determine how many seating components are present in the vehicle. The links could be RF, Bluetooth or some other similar communication standard. The link could be optical or acoustic, either audio or ultrasonic. Seat condition check 471 checks to see if 0, 1, or 2 seats are present in the vehicle, or if there is a system error. If 0 seats are present, the condition check returns a no condition, feedback 472 is provided to the user, and the process stops 413. If an error occurs and the condition check does not complete, an error condition is output, feedback 472 is provided to the user, and the process stops 413. Feedback block 472 provides context sensitive feedback to the user. For the no condition, a flashing red LED can be initiated on FOB 104, on hub 103, or on seating component 500. A fail alarm can be sounded on seating component 500, Fob 104, or hub 103 via audio output devices incorporated into the various components if present, such as speaker 128 of FOB 104, or buzzer 185 on PCB 107 which is located in seating component 500. Detailed feedback can also be provided on the mobile app. running on mobile device 110, which can provide information on the specific condition check that failed. For the error condition, a flashing yellow LED can be initiated on the FOB 104, the hub 103, or the seating component 500. An error alarm (different from the fail alarm) can be sounded on seating component 500, Fob 104, or hub 103 via audio output devices incorporated into the various components if present. Detailed feedback can also be provided on the mobile app. running on mobile device 110, which can provide information on the specific error condition check (such as diagnostic information about an error).

The child transportation system may collect multiple pieces of data when a system error is detected. Any collected data that may be useful to a user that could allow the user to clear the error condition can be reported to the user through the mobile app. running on mobile device 110. Data useful for diagnosing the system fault can be stored for use by a repair technician. Fault data can also be collected and uploaded to a cloud based bug reporting system, so that system faults can be corrected by the manufacturer who can then issue software updates to correct faults.

It can be seen that for the majority of condition checks performed as part the pre-flight check, this structure of a condition check that outputs either a no condition or an error condition, which then are followed by a user feedback block which is followed by a stop, is repeated in numerous places in the flowchart of FIG. 20 (and in additional charts to be discussed). For the sake of brevity, this structure will be referred to as an incomplete condition check process, and these structures and the type of feedback provided will not be described in detail for each occurrence. In general, feedback involving flashing of LED's is similar throughout. Detained feedback provided to mobile device 110 is context sensitive, and will provide information on the specific test that failed and whether the failure was due to failed check or a system error. The discussion above is applicable to all of the conditions checks that have this output structure. Note also that other arrangement of outputs of condition blocks will be described when they occur.

The pre-flight check has been structured such that if a condition check within the pre-flight check routine does not complete for any reason, the pre-flight check routine stops. In one non-limiting example, once the failure or error has been addressed, pressing the pre-flight check button (for example on FOB 104, seating component 500, or hub 103) starts the pre-flight check routine over again from the beginning of the current seating component pre-flight check. If more than one seating component is present and a pre-flight check of one seating component has already been completed, only the current seating component pre-flight check is re-started. In one non-limiting example, pressing the pre-flight check button starts the pre-flight check routine up from the point it stopped, repeating the current condition check that did not complete. In one non-limiting example, the pre-flight check runs through all condition checks without stopping, whether the condition checks complete or not, and reports to the user all condition checks that did not complete. If any condition check fails, feedback is given to the user by one or more of FOB 104, hub 103, or seating component 500 that at least one condition check failed. Detailed feedback is provided by the mobile app. running on mobile device 110, which identifies all condition checks that did not complete (rather than just providing feedback that at least one condition check did not complete) and provides information about the failure if available.

If at least one seating component is present in the vehicle, seat condition check 471 sets a flag based on the number of seating components detected. In one non-limiting example, the flag indicating the number of seating component detected. If a single seating component is detected in the vehicle, pre-flight check continues. If a pair of seating components are detected, each seating component will require its own pre-flight check. In this case, the individual seating component pre-flight checks could be performed serially or in parallel. However, since a likely scenario is one parent securing one child in a first seat and then a second child in a second seat, it can be advantageous to perform individual seat pre-flight checks serially. The flowchart of FIG. 20 assumes multiple seating component pre-flights checks are performed in series when more than one seating component is present. However, it should be understood that child transportation systems disclosed herein are not limited to performing seating component pre-flight checks serially, and a system performing individual seating component pre-flight checks in parallel is also contemplated.

Once the seat condition check 471 has completed, occupancy check 414 is performed. The system checks to see if a child is present in the seat. The occupancy check 414 uses the system occupancy sensors 193 on PCB 107 described earlier, which can be capacitive proximity or optical (IR) sensors, or any other known sense technology useful for determining whether or not the seat is occupied. If the occupancy condition check fails or a system error occurs, an incomplete condition check process runs, feedback 415 is provided to the user and the pre-flight check stops at 416.

If occupancy condition check 414 completes, weight/height condition check 417 runs. The weight/height condition check 417 determines if the child's weight or height fall within the recommended range of weight and height for the specific seating component. Individual seating components will have stored on board their recommended weight/height ranges or predetermined maximum thresholds. System weight sensors as described earlier such as sensor 176 of PCB 102 provide a child weight estimate which is compared to the internal recommended weight range. Weight sensors are typically located in the handle 195 of seating component 500, as described earlier. However, for seats without a handle, weight sensors can be placed in locations underneath the child seating area. Alternatively, weight data can be entered by a user into the mobile app. running on mobile device 110.

Child height data can be measured by the system or input to the system by the user. In one non-limiting example, a camera or a pair of cameras can be mounted to the seating component handle. The dimensions of the seating component body are known, and the handle has a fixed reference position for driving. Image recognition software can be used to identify the child, and the child image size can be compared to known dimensions between reference points on the seating component structure to estimate child height. More complex hardware such as Google Tango 3D camera technology can be used to measure the child's height as well. If the child's weight and/or height lie outside the stored recommended weight and height ranges, weight/height condition check 417 fails. If the weight/height condition check 417 fails or if a system error occurs, an incomplete condition check process runs, feedback 418 is provided to the user and the pre-flight check stops at 419. Detailed information regarding whether the weight test failed or the height test failed can be provided to the user's mobile device 110.

If the weight/height condition check 417 completes, location condition check 420 runs. Location condition check 420 determines whether the seating component 500 is located in a rear seat or a front seat of the vehicle. There are a number of ways in which the location in the vehicle of the seating component can be determined. In one non-limiting example, a reference beacon can be placed in a fixed location in the front of the vehicle, such as clipped to a front seat belt or placed in a glove box in the front passenger side for the vehicle. A receiver can be located either in a seating component or a base to which the seating component is affixed. The receiver can determine its location relative to the reference beacon. In one non-limiting example, an iBeacon/BLE accessory is strapped/clipped/fixed to the front passenger vehicle seat belt. The broadcasting signal power of the beacon is adjusted so that it is detected when the seating component is in the front seat of the vehicle, but is not detected when the child seating component is located in the rear seat of the vehicle. Child transportation systems disclosed are not limited in the manner in which they determine if a seating component is located in a front or rear seat, and other methods for such determining such as optical sense methods, imaging methods, ultrasonic distance measurements and other known methods. are contemplated herein.

If the seating component is determined to be located in the front seat of the vehicle, communication condition check 435 is performed, and if the seat is determined to be located in the rear seat, harness check 483 is performed. If location condition check 420 fails to locate seating component 500 or a system error occurs during the location condition check 420, an incomplete condition check process runs, feedback 481 is provided to the user and the pre-flight check stops at 482.

Communication condition check 435 determines whether or not a communication link is established between system 100 and the vehicle. A communication link to the vehicle will typically be via Bluetooth, as a majority of late model vehicles have Bluetooth communication capability. Vehicle communication could be implemented through Bluetooth module 142 of hub 103, or via Bluetooth module 166 of PCB 101 located in seating component 500, or both. In addition to establishing whether or not a connection with the vehicle exists, system 100 must also determine whether the vehicle exposes an API that would allow system 100 to actuate certain vehicle systems. If system 100 finds this API, disable command 438 is issued to the vehicle to disable the front seat air bags. If a communication with the vehicle is identified, the seat belt disable command 438 is executed. If a communication link is not found or a system error occurs during the communication condition check, an incomplete condition check process runs, feedback 436 is provided to the user and the pre-flight check stops at 437.

If the seat belt disable command is executed, once a confirmation is received back from the vehicle that the air bags have been disabled, the system would proceed to run harness condition check 483. If a confirmation is not received, due to either a failure to execute the command or a system error, an incomplete condition check process runs, feedback 451 is provided to the user and the pre-flight check stops at 452.

Though the communication link with the vehicle described above was only with respect to disabling the front seat air bags, in general it is useful for a child transportation system to establish a communication link with the vehicle. By establishing such a link, user interface portions of the vehicle (displays, alarms, audio output subsystems, etc.) can be used for providing output from the child transportation system to vehicle occupants and receiving input from vehicle occupants and providing that input to the child transportation system. In addition to allowing the vehicle user interface to be used with the child transportation system, a communication link allows the child transportation system to issue commands to various subsystems of the vehicle such as windows (open), door locks (to unlock or prevent from being locked), HVAC systems (turn on air conditioning, provide fresh air), and even engine ignition and shutoff.

Harness condition check 483 runs after either the system has successfully disabled front air bags when the seating component 500 is located in a front seat, or when the seating component has been determined to be located in the rear seat. Harness check 483 analyses the output of harness sensor 179 on PCB 107 to determine if the proper amount of tension has been applied to the harness of seating component 500. The measured tension is compared to a predetermined range of tension stored in system 100 memory. If the applied tension is outside of the predetermined range (where either insufficient or excessive tension has been applied), or if a system error occurs during the harness condition check, the harness check fails. It should be noted that a sensor such as a contact switch could be added to the harness buckle to determine whether or not the harness buckle is fully latched. If such a sensor is present in the buckle, harness check 483 would check both harness tension and buckle latch. If either or both of the tension and buckle check fails, an incomplete condition check process runs, feedback 424 is provided to the user and the pre-flight check stops at 425. Detailed feedback can be provided to the user identifying whether the tension, buckle latch, or both checks failed, or whether a system error occurred.

The flow chart of FIG. 20 shows two branches out of the harness condition check 483, as there are two variations of seating components that can be used—seating components with handles and rotating seating components without handles. Since the seating component 500 will know whether or not it has a handle, there is no need for a “handle check” to determine whether or not the seating component includes a handle. Seating components with handles will proceed automatically to handle position condition check 426, and rotating seating components without handles will proceed automatically to look direction condition check 439.

For seating components with handles, after harness condition check 483 completes, handle position condition check 426 runs. Handle position condition check 426 determines whether or not handle 195 of seating component 500 is fixed in the reference driving position. Hall sensor 168 is queried, and if the output from hall sensor 168 is high (due to it being aligned with magnet 197 located in the seating basket 198 of seating component 500), the handle is determined to be in the reference driving position. If the output of hall sensor 168 is not high, the handle position condition check fails. If the handle position condition check fails or a system error occurs, an incomplete condition check process runs, feedback 427 is provided to the user and the pre-flight check stops at 428. If the handle position condition check completes, Isofix base condition check 429 runs.

Isofix base condition check 429 checks to see if an Isofix base is present. If an Isofix base is determined to be present, Isofix base condition check completes and Isofix connector condition check 432 runs. If an Isofix base is determined not to be present, seat belt routing check 442 runs. If a system error occurs and Isofix base condition check 429 does not complete, feedback 430 is provided to the user and the pre-flight check stops at 431, where the feedback to the user can include a flashing yellow LED indicating system error, and/or detailed feedback to the user via the mobile app. running on mobile device 110 that identifies an error has occurred and provides information about the error if available. The Isofix base condition check 429 queries sensor 192, which in one non-limiting example is a momentary contact switch located on a bottom surface of seating component 500. The momentary contact switch is located in a position on the bottom of seating component 500 such that the switch will be closed if the seat is fit into an Isofix base, but will not be closed if seating component rests directly on a vehicle seating surface. If sensor (switch) 192 is closed, Isofix base condition check determines that an Isofix base is present, and if sensor 192 is open, Isofix base condition check determines that an Isofix base is not present. It is understood that a mechanical contact switch is not the only mechanism that can be used to determine if the Isofix base is present. For example, a hall effect device mounted to the underside of the seating component and magnet mounted in the Isofix base in an arrangement as disclosed for the handle position sensor provides an alternative method to sense the presence of the Isofix base (though it does require modification to an Isofix base to function whereas the contact switch does not). Examples of child transportation systems are not limited in the methods used to determine if an Isofix base is present.

Referring again back to harness condition check 483, if a rotating seating component without a handle is present, after harness condition check 483 completes, look direction condition check 439 runs. Look direction condition check 439 determines whether the seating component 500 is facing in the correct direction based on the child's weight and height, and if available the child's age, and whether the rotation of a rotating seat is locked. The seating component look direction is determined by comparing outputs of the ecompass module 177 located on PCB 102 which is located in seating component 500, with the output of ecompass module 146 included in hub 103. Ecompass module 146 provides a measurement of the earth's magnetic field in the vehicle frame of reference that the output from the seating component ecompass module can be compared to, to easily determine what direction the seating component is facing. Weight and height information are available from weight/height condition check 417 run earlier. The child age information can be available to system 100 if entered by a user into the mobile app. running on mobile device 110. The child's weight and height (and age if available) are checked against information stored within system 100 identifying weight and height (and age) predetermined thresholds. If the child's weight or height (or age) are below the predetermined thresholds, the required seating component orientation is rear facing, and if the child's weight and height (and age) exceed the predetermined thresholds, the required seating component orientation is forward facing. The location check compares the required facing direction with the actual seating component facing direction. If the directions match, the look direction condition check 439 completes. If the required and actual look directions do not match or a system error occurs, the look direction condition check 439 fails and an incomplete condition check process runs, feedback 440 is provided to the user and the pre-flight check stops at 441. Detailed feedback provided to the user on mobile device 110 can identify the reason for the fail (weight or height or age, or combination thereof not sufficient for forward facing orientation, or are excessive for a rearward facing orientation), or identify that a system error occurred. If look direction condition check 439 completes, Isofix connector condition 432 check is run.

Rotation lock can be determined by incorporating a position sensor or pair of position sensors of some type into the seating component that provide seat rotation information. The exact configuration of a sensor or sensors depends on the nature of the lock mechanism used, but it is well known in the art how to fabricate such sensors. For example, electrical contact switches can be incorporated such that a switch only closes when a positive lock condition exists. By using one switch for each locked seat position, seat look direction can be determined by determining which switch is closed.

Referring again to Isofix base condition check 429, if Isofix base condition check determines that an Isofix base is not present (sensor 192 remains open), seat belt routing condition check 442 runs. If an Isofix base is not present, the seating component 500 must be secured to the vehicle by routing the vehicle seat belts through routing locations provided on seating component 500. Seat belt routing condition check 442 looks to see if three seat belt sensors 191 are actuated. Proper seat belt routing, as described earlier, requires that the lap belt portion of the vehicle seat belt be routed through a pair of belt routing locations positioned on the sides of seating component 500, and the shoulder strap portion of the vehicle seat belt be routed through one of a pair of shoulder belt routing locations on the back of seating component 500. If the required sensors 191 are closed (three sensors in the current application), seat belt routing condition check 442 completes and seat orientation condition check 443 runs. If one or more of sensors 191 are not actuated and seat belt routing condition check 442 fails or a system error occurs, an incomplete condition check process runs, feedback 444 is provided to the user and the pre-flight check stops at 445. Detailed feedback can be provided to the user identifying which seat belt routing location is not properly used, or will identify if a system error has occurred and provide information on the error if available.

Seat orientation condition check 443 determines if seating component 500 is properly oriented on the vehicle seat when it is secured to the vehicle using the vehicle seat belts. Even if it has been determined that the vehicle seat belts are properly routed through the routing locations on seating component 500, it is possible for the seat to be improperly oriented. The seat orientation measurement process described earlier is performed here. The system performs a measurement of seating component orientation by querying low g IMU 173 on PCB 102. It should be noted that IMU 173 is located in the handle 195 of seating component 500. The pre-flight check has already determined in handle position condition check 426 that the handle is located in the reference driving position. This guarantees that the IMU is always located in the same location relative to the rest of seating component 500 when the seating component orientation measurement is made. Using the Madgwick algorithm as described earlier, the orientation of the seating with respect to earth is calculated from sampled IMU data. As described earlier, the previously stored information of the hub 103 location with respect to the vehicle frame of reference obtained during system calibration is used to provide a vehicle frame of reference so that a seat orientation measurement with respect to the vehicle is obtained. The seat orientation measurement with respect to the vehicle is compared to stored data representing a desired orientation and an error calculation is made. If the measurement matches the stored orientation within a predetermined level of error, orientation is determined to be acceptable and seat orientation condition check 443 completes.

If the level of error exceeds the predetermined level of error or if a system error occurs so that the seat orientation condition check 443 fails to complete, an incomplete condition check process runs, feedback 446 is provided to the user and the pre-flight check stops at 447. Detailed feedback can be provided to the user identifying the nature of the failure, for example the type of orientation error, the level of orientation error or a that a system error has occurred, and provide information on the error if available.

If seat orientation condition check 443 completes, the rotating seating component has passed its full pre-flight check.

Returning again to Isofix base condition check 429, if Isofix base condition check 429 completes and it is determined that a base is present, Isofix connector condition check 432 runs. Isofix connector condition check 432 queries Isofix sensors 192 to determine if the seating component is properly latched to the Isofix base. Additionally, if Isofix connector sensors are present in the system, Isofix connector condition check 432 also queries these sensors to determine if the Isofix base is properly latched to the vehicle. If Isofix connector condition check 432 completes, the seating component has passed its full pre-flight check. If Isofix connector condition check 432 fails to complete because one or more of Isofix sensors or Isofix connector sensors indicate an unlatched condition or because of a system error, an incomplete condition check process runs, feedback 433 is provided to the user and the pre-flight check stops at 434.

If seat check 471 returned a flag with the second pre-defined value signifying that two seating components are present in the vehicle, a second pre-flight check then runs on the second seating component. Dotted section 450 surrounds all the elements of the pre-flight check described for the first seating component that would need to be repeated for the second seating component pre-flight check. Since the pre-flight check for the second seat would be identical to the section 450 already described, description of a second seat pre-flight check will not be provided. If the second seating component pre-flight check completes, feedback 461 is provided to the user stating that both pre-flight checks have passed, and the pre-flight check process finishes 462. If seat check 471 returned a first predetermined value because only one seating component is present and its pre-flight check passes, feedback 461 is provided to the user that the pre-flight check passed, and the pre-flight check process finishes. Feedback can be flashing green LED's on various components of the system such as FOB 104, hub 103, each seating component 500, and be provided on mobile device 110 which can display more complex feedback such as alphanumeric text stating all checks passed on all seats.

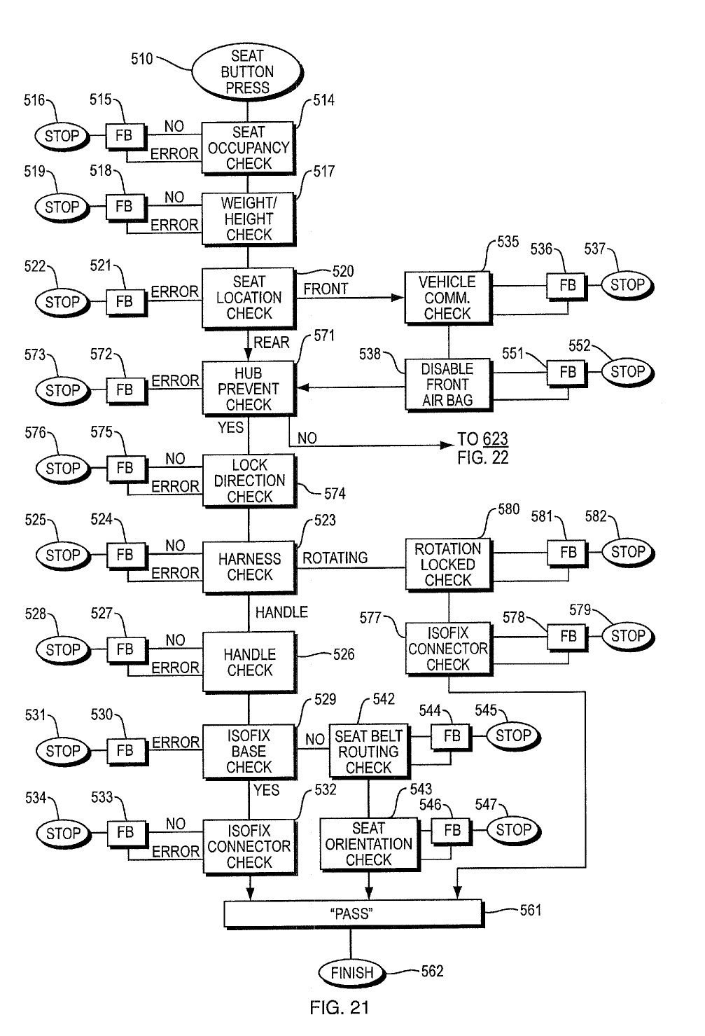

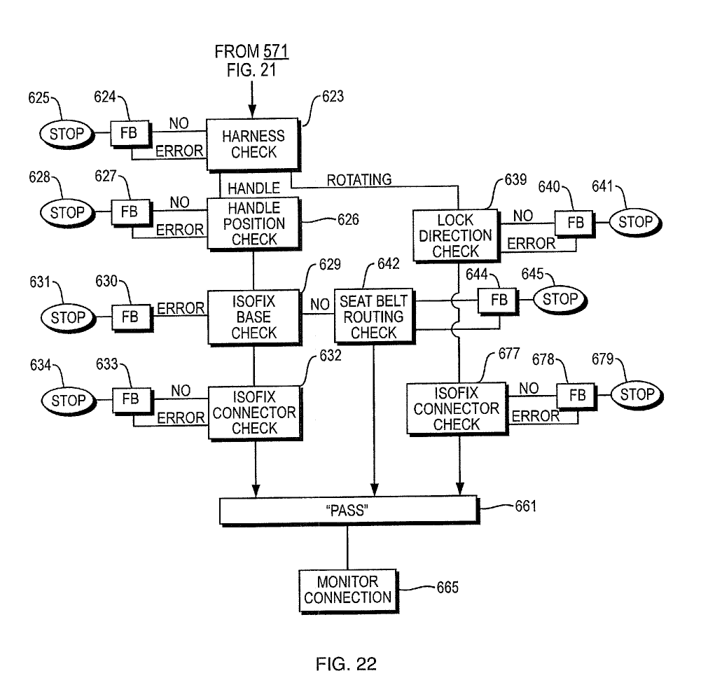

If a pre-flight check is triggered by actuating a control surface located on seating component 500 of child transportation system 100, a pre-flight check described by the flow charts in FIGS. 21-22 will run. There is a large degree of similarity between this pre-flight check and the pre-flight checks initiated by actuating a key FOB button shown in FIG. 20, but the check are not identical. However, the purpose is still to check if the correct seating component is being used for the child, to check that the seating component is properly secured in the vehicle, to check that the child is properly secured in the seat, and to check that the system is functioning properly. The differences in the flow charts arise because in one instance it is known that a wireless connection between elements of the system exists, while in the case of actuating the seating component control surface it is not known at the time the pre-flight check is initiated if all of the system components are present (a seat could be installed in a vehicle without a hub, for example). As such, the order of certain operations can change, and in some process branches certain checks may not be performed because not all system components are present. Sections of FIGS. 21-22 that are the same as in FIG. 20 will be identified but will not be described in detail as the description of the like sections of

FIG. 20 are applicable. Differences will be identified and described. Like reference numbers for similar elements are used where possible.

Referring now to FIG. 21, a pre-flight check is initiated by actuating a control on the seating component of system 100. The pre-flight check begins by running seat occupancy condition check 514. If seat occupancy condition check 514 completes, weight/height condition check 517 is then run. If weight/height condition check 517 completes, seat location condition check 520 is run. If either of checks 514 and 517 fails or if there is a system error when either check is running, an incomplete condition check process runs, feedback (515 or 518 respectively) is provided to the user and the pre-flight check stops (at 516 or 519 respectively). If a system error occurs during the seat location condition check 520, feedback to the user is provided at 521 and the pre-flight check stops at 522. The checks 514, 517 and 520 are the same as checks 414, 417, and 420 of FIG. 20 so their descriptions will not be repeated here.

If seat location condition check 520 determines that the seating component is located in the front seat of the vehicle, communication condition check 535 runs. If communication condition check 535 completes, disable front air bag command 538 is issued. If the disable front air bag command 538 completes, the hub presence condition check 571 runs. If either communication condition check 535 or the disable front air bag command 538 do not complete, either because of a fail or a system error, an incomplete condition check process runs, feedback (536, or 551 respectively) is provided to the user and the pre-flight check stops (at 537 or 552 respectively). The checks 535 and 538 are the same as checks 435 and 438 of FIG. 20 so their descriptions will not be repeated here.

Hub presence condition check 571 checks to see if a hub is present. Because the pre-flight check was initiated using the seating component control surface, it is possible a hub is not present. System 100 checks to see if a communication link has been established with the hub, either via Bluetooth or an RF connection. If desired the hub condition check could cause a message to be sent by the seating component 500 to the hub 103 requesting a return message to be sent from hub 103 back to the seating component 500. Receipt of this message back from the hub 103 would provide confirmation that the hub 103 is present.

1002661 If seat location check 520 determines that the seating component is located in the rear seat of the vehicle, hub presence condition check 517 runs. Operation of hub presence check 571 is described above. If the hub presence condition check 571 fails, a hub has not been found. The remaining steps in the pre-flight check for this condition are shown in FIG. 22. If the hub is determined to be present, hub presence condition check 571 completes and look direction condition check 574 runs. If an error in system operation occurs, feedback is provided to the user at 572 and operation stops at 573.

Look direction condition check 574 determines what direction the seating component is facing. Look direction condition check 574 functions identically to look direction condition check 439 of FIG. 20, and the description of look direction condition check 439 provided earlier is directly applicable here so the detailed description will not be repeated. If the look direction condition check 574 completes, the system has determined that the seating component is facing in the recommended direction for the child occupying the seat. Once check 574 completes, harness condition check 523 runs. If Look direction condition check 574 does not complete, either because of a fail or a system error, an incomplete condition check process runs, feedback 575 is provided to the user and the pre-flight check stops at 576.

If look direction condition check 574 completes, harness condition check 523 runs. Harness condition check 523 functions identically to harness condition check 483 of FIG. 20, and the description of harness condition check 483 provided earlier is directly applicable here so the detailed description will not be repeated. If the harness condition check 523 completes, the system has determined that the seating component harness is properly tensioned, and that the harness buckle is latched (if a buckle sensor is included in system 100). If harness condition check 523 does not complete, either because of a fail or a system error, an incomplete condition check process runs, feedback 524 is provided to the user and the pre-flight check stops at 525.

If harness condition check 523 completes, there are two paths. In one path for seating components with handles, handle condition check 526 runs. In the second path for rotating seats, rotation lock condition check 589 runs. If harness condition check 523 does not complete, either because of a fail or a system error, an incomplete condition check process runs, feedback 524 is provided to the user and the pre-flight check stops at 525.

Harness condition check 523, handle condition check 526, Isofix base condition check 529, Isofix connector condition check 532, seat belt routing condition check 542, seat orientation check 543, and all of their associated incomplete condition check processes incorporating feedback 524, 527, 530, 533, 544 and 546, and stop locations 525, 528, 531 534, 545, and 547, are identical to similarly numbered checks 483, 426, 429, 432, 442 and 443 and their associated incomplete condition check processes incorporating feedback 424, 427, 430, 433, 444 and 446, and stop locations 425, 428, 431 434, 445, and 447 of FIG. 20. The descriptions of those elements provided earlier with reference to FIG. 20 are also applicable to the like elements incorporated in FIG. 21 identified above, and so their detailed descriptions will not be repeated here.

If harness condition check 523 completes, handle condition check 526 runs. If handle condition check 526 completes, the system has determined that the seating component handle is located in the reference driving position. If handle condition check 526 does not complete, either because of a fail or a system error, an incomplete condition check process runs, feedback 527 is provided to the user and the pre-flight check stops at 528.

If handle condition check 526 completes, Isofix base condition check 529 runs. If an Isofix base is determined to be present Isofix base condition check 529 completes and Isofix connector condition check 532 runs. If no Isofix base is detected, seat belt routing condition check 542 runs. If Isofix base condition check 529 fails to complete because of a system error, feedback 530 is provided to the user and the pre-flight check stops at 531.

If an Isofix base was detected, Isofix base condition check 529 completes and Isofix connector condition check 532 runs. Isofix connector condition check 532 functions identically to Isofix connector condition check 432 of FIG. 20, and the description of Isofix connector condition check 432 provided earlier is directly applicable here so the detailed description will not be repeated. If the Isofix connector condition check 532 completes, the Isofix connectors are determined to be properly latched and the complete pre-flight system check has passed. If Isofix connector condition check 532 does not complete, either because of a fail or a system error, an incomplete condition check process runs, feedback 533 is provided to the user and the pre-flight check stops at 534.

If an Isofix base was not detected, seat belt routing check 542 runs. Seat belt routing check 542 functions identically to seat belt routing check 442 of FIG. 20, and the description of seat belt routing check 442 provided earlier is directly applicable here so the detailed description will not be repeated. If the seat belt routing check 542 completes, the system has determined that the vehicle seat belt is properly routed through the routing points on the seating component. If seat belt routing check 542 does not complete, either because of a fail or a system error, an incomplete condition check process runs, feedback 544 is provided to the user and the pre-flight check stops at 545.

If seat belt routing condition check 542 completes, seat orientation condition check 543 runs. Seat orientation condition check 543 functions identically to seat orientation condition check 443 of FIG. 20, and the description of seat orientation condition check 443 provided earlier is directly applicable here so the detailed description will not be repeated. If the seat orientation condition check 543 completes, the system has determined that the seating component is properly oriented, and the complete pre-flight system check has passed. If seat orientation condition check 443 does not complete, either because of a fail or a system error, an incomplete condition check process runs, feedback 546 is provided to the user and the pre-flight check stops at 547.

For rotating seating components, if harness condition check 523 completes, rotation lock condition check 580 runs. Rotation lock condition check 580 checks to see if the seating component is fully rotated and locked into position by querying rotation lock sensors, as described earlier. If rotation lock condition check 589 determines that the seating component is locked in position, Isofix connector check 577 runs. If rotation lock condition check 580 does not complete, either because of a fail or a system error, an incomplete condition check process runs, feedback 581 is provided to the user and the pre-flight check stops at 582.

If rotation lock condition check 589 completes, Isofix connector condition check 577 runs. Isofix connector condition check 77 functions identically to Isofix connector condition check 432 of FIG. 20, and the description of Isofix connector condition check 432 provided earlier is directly applicable here so the detailed description will not be repeated. If the Isofix connector condition check 577 completes, the Isofix connectors are determined to be properly latched and the complete pre-flight system check has passed. If Isofix connector condition check 532 does not complete, either because of a fail or a system error, an incomplete condition check process runs, feedback 578 is provided to the user and the pre-flight check stops at 579.

If Isofix connector condition check 532 completes, or if seat orientation condition check 543 completes, or if Isofix connector check 577 completes, the pre-flight check has passed. Feedback 561 is provided to the user by flashing LED's green on either the seating component 500 of the hub 103 (and key FOB 104 if available). Detailed feedback can be provided to the user via the mobile app. running on remote mobile device 110. Once the feedback has been provided, the pre-flight check is complete.

FIG. 22 continues the flowchart of FIG. 21 showing the remainder of the operations that run in the “no” branch output of hub presence condition check 571. If the result of hub presence condition check 571 is that no hub is found, harness condition check 623 on FIG. 22 runs. If harness condition check 623 completes, for seating components with a handle, handle position condition check 626 runs. If harness condition check 623 completes, for rotation seating components, look direction condition check 639 runs. It should be noted that harness condition check 623 and handle position condition check 626 are identical to harness and handle position condition checks 483, 523, and 426, 526. These checks were described earlier so their detailed descriptions will not be repeated here. If either of checks 623 and 626 do not complete, either because of a fail or a system error, an incomplete condition check process runs, feedback (at 624 or 627 respectively) is provided to the user and the pre-flight check stops (625 or 628 respectively).

Look direction condition check 639 checks to see if the seating component is facing the correct direction given the child's weight, height, and age (if available). However, look direction condition check 639 cannot determine the look direction by comparing the output of an ecompass module located on the seating component with an ecompass module located on the hub because hub 103 is not present. In this case, since look direction condition check 639 executes when the seating component is of the rotating type, sensors can be placed in the seat to identify if the seat is forward or rearward facing. Weight and height information obtained from weight/Height condition check 517 is compared to stored recommended facing direction information for the seating component. The recommended facing direction given the weight and height obtained from check 517 is compared to the actual facing direction determined by the sensors (which can be simple contact switches, hall effect devices, optical switches, or other position determining sensors) incorporated in the rotating seat. If the recommended and sensed facing directions match, look direction condition check 639 completes and Isofix connector condition check 677 runs. If look direction condition check 639 does not complete, either because of a fail or a system error, an incomplete condition check process runs, feedback 640 is provided to the user and the pre-flight check stops 641.

Isofix connector condition check 677 is identical to Isofix connector condition checks (432, 532, 577) described earlier so the detailed description will not be repeated here.

If Isofix connector condition check 677 completes, the Isofix connectors were determined to be properly latched and the complete pre-flight system check has passed.

If handle position condition check 626 completes, Isofix base condition check 629 runs. Isofix base condition check 629 is identical to earlier described Isofix base condition checks 429 and 529, and the descriptions provided earlier are applicable here and will not be repeated. If Isofix base condition check 629 determines an Isofix base is present, Isofix connector condition check 632 runs. If Isofix base condition check 629 determines an Isofix base is not present, seat belt routing condition check 642 runs. If Isofix base condition check 629 fails to run because of a system error, feedback 630 is provided to the user, and the process stops at 631

Isofix connector condition check 632 runs of an Isofix base is detected. Isofix connector condition check 632 is identical to earlier described Isofix connector condition checks 432, 532, 577 and 677. The descriptions provided earlier are applicable here and will not be repeated. If Isofix connector condition check 632 completes, the system has determined that the Isofix connectors are properly latched, and the complete pre-flight system check has passed. If Isofix connector condition check 632 does not complete, either because of a fail or a system error, an incomplete condition check process runs, feedback at 633 is provided to the user and the pre-flight check stops at 634.

If an Isofix base is not detected, seat belt routing condition check 642 runs. Seat belt routing condition check 642 is identical to earlier described seat belt routing condition checks 442 and 542. The descriptions provided earlier are applicable here and will not be repeated. If seat belt routing condition check 642 completes, the pre-flight check passed.

It should be noted that a seat orientation check has not been performed. The seat orientation check requires that a hub be present. Since the hub is not present in this case, the orientation condition check is omitted.

If Isofix connector condition check 632, seat belt routing condition check 642 or Isofix connector condition check 677 completes, the complete pre-flight system check has completed. Feedback 661 is given to the user where LED's on various system components (seating component 500, key FOB 104) may turn solid or flash green, and detailed feedback can be provided to the user via the mobile app. running on remote mobile device 110. If Isofix connector condition check 677 does not complete, either because of a fail or a system error, an incomplete condition check process runs, feedback 678 is provided to the user and the pre-flight check stops 679.

After the pre-flight check completes, system 100 monitors the car movement direction, and compares the car movement direction with the child seat direction at Monitor Direction block 665. This process continues to run until the system can make a determination that the seat movement direction matches or does not match the car movement direction. The process stops if the child seat is removed from the vehicle, or the system 100 has determined that the car motion has stopped for a period of time that exceeds a predetermined threshold time for monitoring. Car motion is monitored using GPS module 170 located on PCB 102 which is incorporated into seating component 500. Ecompass module 177, also incorporated on PCB 102, monitors seating component direction. The relationship between the heading from GPS module 170 is compared to a heading obtained from the ecompass module. If the headings change over time by more than a predetermined threshold level, monitoring block 665 determines that the seating component 500 has shifted position in the vehicle and an alarm condition is triggered. The alarm condition can cause LED's on various system components to flash red, for example on seating component 500 and on key FOB 104. The alarm condition can trigger an alarm on mobile device 110.

Audible outputs can also be triggered to be output by buzzer 185 on PCB 107 included in seating component 500, or on mobile device 110. More detailed information about the alarm can also be provided to mobile device 110 through the mobile app. or alternatively through text messaging or through any other communication link that exists between seating component 500 and mobile device 110.

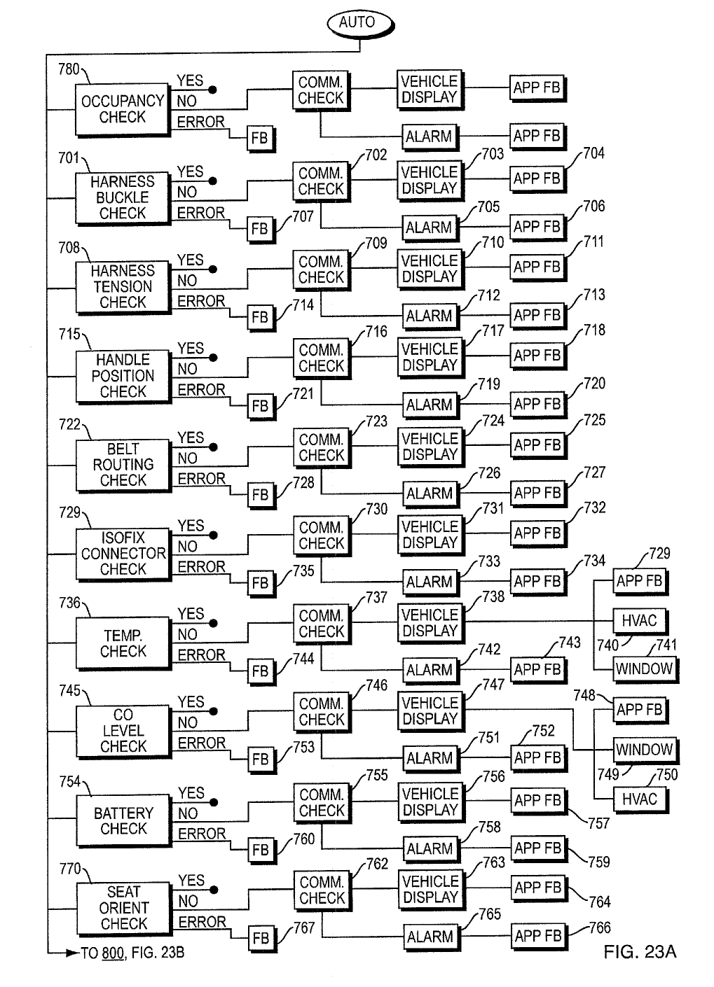

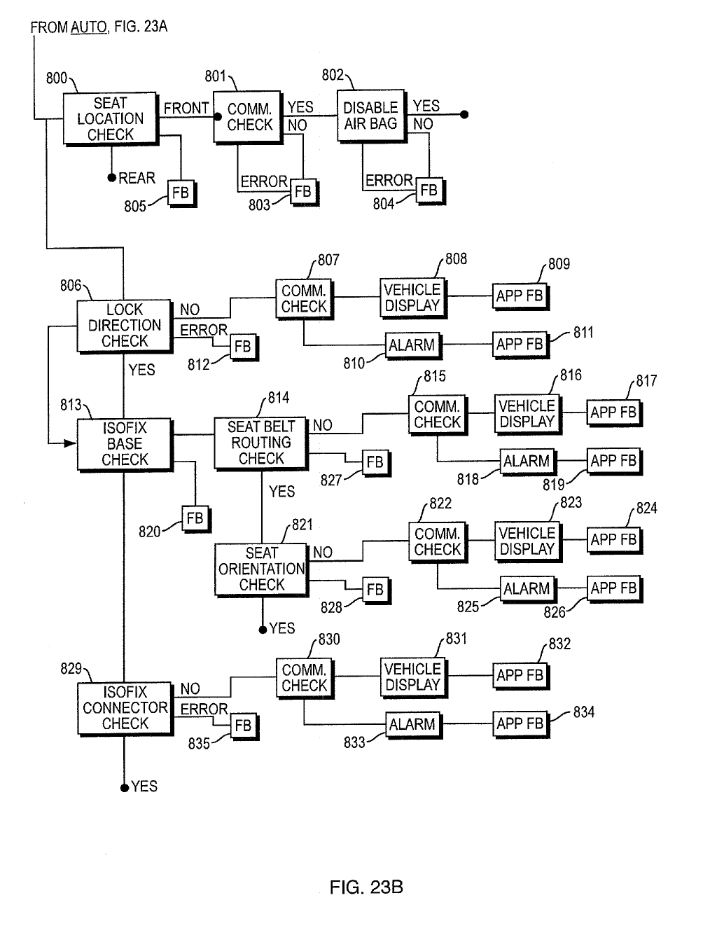

As previously described, a pre-flight check can be initiated by a specific action of the user (actuating a control surface of a key FOB, of the seating component, of the hub, or of the mobile device running the mobile app.). An alternative system check can be initiated automatically by the system when it senses that a trip has started, when a user has not initiated a pre-flight check, without a direct action being taken by the user. The automatic system check then differs from the pre-flight check in that it is executed once a vehicle trip is underway, but the system test shares many similarities with the operations performed during the pre-flight check. Flowcharts for one non-limiting example system check are depicted in FIGS. 23A-23B, and are described in detail below. The system may also maintain an ongoing system operational condition check. This check is similar to the automatic check depicted in

FIG. 23A-23B, but with possibly minor differences. For example, for the ongoing system operational condition check it is not necessary to continuously monitor the child's weight and height. It is assumed that once a trip has started, as long as the child has not been removed from the seating component, which can be monitored by an occupancy check, it is not necessary to monitor the child's weight or height. An ongoing operating system condition check may perform a subset of the condition checks performed in the automatic system check described in FIGS. 23A-23B.

Child transportation system 100 can initiate an automatic system check if it detects a trip has started. Referring now to FIGS. 23A-23C, automatic system check starts at start 700. The flowcharts in FIGS. 23A-23C shows checks 701, 708, 715, 722, 729, 736, 745, 754, 770, 776, and 801 arranged in parallel. The actual checks can be performed either in parallel or in series and examples of child transportation systems disclosed herein are not limited in the specific arrangement of checks performed in the automatic system check.

Harness buckle check determines whether the seating component harness belt is properly latched. This requires that sensors be located in the harness buckle capable of determining if the buckle is latched. Such sensors are not specifically shown in the figures, but are well known in the art. If the buckle is determined to be latched, the process check stops. If the buckle is determined not to be latched, vehicle communication check 702 runs.

If check 702 determines that communication with the vehicle is established, vehicle display command 703 executes. Command 703 sends a context sensitive message to a display device in the vehicle, to display a message to the user that the buckle is unlatched. Command 703 could also cause an alarm to sound. The alarm could be output through audio rendering devices included as part of child transportation system 100, or the command could cause an audio rendering device of the vehicle to output an alarm sound. Once command 703 has executed, additional feedback 704 is provided to the user via the mobile app. running on mobile device 110. The feedback 704 provided to mobile device 110 could cause mobile device 110 to display visual information and/or to output an audible alarm. The information displayed or audible output could provide specific information about the specific check that has failed.

If communication with the vehicle is not established, an alarm condition 705 is triggered and feedback 706 is provided to the user via the mobile app. running on mobile device 110. Visible and audible alarms can also be triggered on components of system 100 so that various LED's and audio rendering devices included in system 100 are actuated. If a system error occurs during the harness buckle check 701, feedback 707 is also provided to the user. For example, flashing yellow LED's can be triggered on components of system 100, and detailed information about the error can be provided via the mobile app.

The above described structure repeats for a large number of the checks 701, 708, 715, 722, 729, 736, 745, 754, 770, 776, and 801, where the only difference may be the specific information provided when feedback is generated (the context of context sensitive feedback). For the sake of brevity, each instance of this structure will not be fully described. Reference will be made to the above discussion, where for a result of a check being a no condition, the structure that executes after the no condition will be referred to as the “communication chain process”. In the above discussion, the communication chain process consists of blocks 702, 703, 704, 705, and 706.

Harness tension check 708 checks the tension in the seating component harness. The harness check is performed in the same manner as described earlier for harness condition check 483, 523 and 623, so the description will not be repeated here. If harness condition check 708 determines that the harness tension is in the correct range, the harness check stops. If harness tension is determined to not be in the correct range, a communication chain process comprising blocks 709, 710, 711, 712, and 713 runs, where feedback to the user can identify that the tension is out of range. If a system error occurs during the harness tension check 708, feedback is also provided to the user. For example, flashing yellow LED's can be triggered on components of system 100, and detailed information about the error can be provided via the mobile app.

Handle position check 715 checks that the handle is in the reference driving position. Handle position check 715 is performed in the same manner as described earlier for handle position checks 426, 526 and 626, so the description will not be repeated here. If handle position check 715 determines that the seating component handle is in the correct reference driving position, the handle position check stops. If handle position is determined to not be in the correct reference position, a communication chain process comprising blocks 716, 717, 718, 719, and 720 runs, where feedback to the user can identify that the handle is out of position. If a system error occurs during the handle position check 715, feedback 721 is also provided to the user. For example, flashing yellow LED's can be triggered on components of system 100, and detailed information about the error can be provided via the mobile app.

Belt routing check 722 checks that the vehicle seat belt is routed through three routing locations on the seating component of system 100. Belt routing check 722 is performed in the same manner as described earlier for belt routing checks 442, 542, and 642, so the description will not be repeated here. If belt routing check 722 determines that the vehicle seat belt is properly routed through three seat belt routing locations on the seating component, the belt routing check stops. If the vehicle seat belt is determined to not be properly routed, a communication chain process comprising blocks 723, 724, 725, 726, and 727 runs, where feedback to the user can identify that the vehicle seat belt is not properly routed. If a system error occurs during the belt routing check 722, feedback 728 is also provided to the user. For example, flashing yellow LED's can be triggered on components of system 100, and detailed information about the error can be provided via the mobile app.

Isofix connector check 729 checks that the Isofix connectors are properly latched. Isofix connector check 729 is performed in the same manner as described earlier for Isofix connector checks 432, 532, 577, 632, and 677, so the description will not be repeated here. If

Isofix connector check 729 determines that the Isofix connectors are properly latched, the Isofix connector check stops. If the Isofix connectors are determined to not be properly latched, a communication chain process comprising blocks 730, 731, 732, 733, and 734 runs, where feedback to the user can identify that the Isofix connectors are not properly latched. If a system error occurs during the Isofix connector check 729, feedback 735 is also provided to the user. For example, flashing yellow LED's can be triggered on components of system 100, and detailed information about the error can be provided via the mobile app.

Temperature check 736 checks that the temperature in the ambient environment near the seating component 500 of system 100 is not in a dangerous temperature range. Temperature check 736 compares a measured temperature obtained from a temperature sensor in the child transportation system such as sensor 190 on PCB 107 to one or more predetermined threshold values stored in memory of system 100. If temperature check 736 determines that the measured temperature is within a safe range (or below a predetermined threshold value representative of a dangerous condition), the temperature check 736 stops. If the measured temperature is determined to be in a dangerous range, or to exceed a predetermined threshold value representative of a dangerous condition, a communication chain process comprising blocks 737, 738, 739, 742, and 743 runs, where feedback to the user can identify that a dangerous temperature condition exists. If a system error occurs during the temperature check 736, feedback 744 is also provided to the user. For example, flashing yellow LED's can be triggered on components of system 100, and detailed information about the error can be provided via the mobile app.

Two additional blocks 740 and 741 appear in the communication chain process mentioned above. These blocks represent additional commands that can be sent to the vehicle if vehicle communication has been established. For temperature check 736 (and for CO check 745 described below), it is possible for operations undertaken by the vehicle to mitigate a dangerous condition. In the case of a dangerous (high) temperature, a command 741 can be sent to the vehicle to open one or more windows, and a command 740 can be sent to the vehicle to turn on air conditioning in an HVAC system. If desired, a command (not shown in the flowchart) could also be sent to the vehicle to unlock the vehicle doors. A command could be sent to start the vehicle engine prior to starting the HVAC air conditioning system if the vehicle was not running.

CO check 745 checks that the amount of CO present in the ambient environment near the seating component 500 of system 100 does not exceed a predetermined threshold representative of a dangerous condition. CO check 745 compares a measured CO level obtained from a CO sensor in the child transportation system such as sensor 194 on PCB 107 to a predetermined threshold level stored in memory of system 100. If CO check 745 determines that the measured CO level is below a predetermined threshold value representative of a dangerous condition, CO check 745 stops. If the measured CO level is determined to be in a dangerous range, or to exceed a predetermined threshold value representative of a dangerous condition, a communication chain process comprising blocks 746, 747, 748, 751, and 752 runs, where feedback to the user can identify that a dangerous level of CO condition exists. If a system error occurs during the CO check 745, feedback 753 is also provided to the user. For example, flashing yellow LED's can be triggered on components of system 100, and detailed information about the error can be provided via the mobile app.

Two additional blocks 749 and 750 appear in the communication chain process mentioned above. These blocks represent additional commands that can be sent to the vehicle if vehicle communication has been established. For CO check 745, it is possible for operations undertaken by the vehicle to mitigate a dangerous condition. In the case of a dangerous (high) level of CO present, a command 749 can be sent to the vehicle to open one or more windows, and a command 750 can be sent to the vehicle to turn on the HVAC system to draw in fresh air. If desired, a command (not shown in the flowchart) could also be sent to the vehicle to unlock the vehicle doors. Also not shown, a command could be sent to shut off the vehicle engine if the vehicle is not moving and the transmission is in park.

Battery check 754 checks the level of energy left in the seating component batteries 162 (and 161 if present) on PCB 101, battery 120 on FOB 104, battery 140 on hub 103. Battery check 754 queries battery monitor 159 on PCB 101, microprocessors 123 and 143 to determine the remaining battery energy. The amount of remaining energy is compared to a stored predetermined threshold level representative of approx. 3 days' worth of operating time. If battery check 754 determines that the remaining amount of energy in the batteries is above the predetermined threshold level, battery check 754 stops. If Battery check 754 determines that a level of remaining battery energy is below the predetermined threshold level for any battery being checked, a communication chain process comprising blocks 755, 756, 757, 758, and 759 runs, where feedback to the user can identify that the remaining battery charge is low and the batteries need to be recharged. If a system error occurs during the battery check 754, feedback 760 is also provided to the user. For example, flashing yellow LED's can be triggered on components of system 100, and detailed information about the error can be provided via the mobile app.

Seat orientation check 770 determines if the seating component is properly oriented in the vehicle. Seat orientation check 770 is performed in the same manner as seat orientation checks 443, 543 described earlier, so the description will not be repeated here.

Seat orientation check 770 measures the seat orientation by comparing outputs from a first IMU located in the seating component handle 195 with the output of a second IMU located in the hub 103, in order to obtain a measurement of the seat orientation in the vehicle frame of reference. The determined orientation is compared with stored information describing a predetermined range of proper orientation within the vehicle. If the measured orientation is within the predetermined range of proper orientation, seat orientation check 770 stops. If seat orientation check 770 determines that the measured orientation is outside of the proper range of orientation, a communication chain process comprising blocks 762, 763, 764, 765, and 766 runs, where feedback to the user can identify that the seat orientation is not within the recommended range. If a system error occurs during the seat orientation check 770, feedback 767 is also provided to the user. For example, flashing yellow LED's can be triggered on components of system 100, and detailed information about the error can be provided via the mobile app.

Referring now to FIG. 23B, seat location check 800 determines whether the seating component of child transportation system is located in a front or rear seat of a vehicle. Seat location check 800 is performed in the same manner as seat location checks 420, 520 described earlier, so the description will not be repeated here. If seat location check 800 determines that seating component 500 is located in a rear seat of the vehicle, seat location check 800 stops. If seat location check 800 determines that seating component 500 is located in a front seat of the vehicle, communication check 801 runs. If a system error occurs during the seat location check 800, feedback 805 is also provided to the user. For example, flashing yellow LED's can be triggered on components of system 100, and detailed information about the error can be provided via the mobile app.

Communication check 801 checks to see if there is a communication link between child transportation system 100 and the vehicle. Communication check 801 is performed in the same manner as communication checks 435, 535 described earlier, so the description will not be repeated here. If communication check 801 determines that a communication link with the vehicle is present, disable air bag command 802 is issued. If communication check 801 determines that a communication link with the vehicle is not present, feedback is provided to the user, where feedback to the user provides a warning that the child seat is located in a front seat but the front seat air bags are not deactivated. The system can recommend the user place the seating component in the rear seat of the vehicle. If a system error occurs during the communication check 801, feedback 803 is also provided to the user.

For example, flashing yellow LED's can be triggered on components of system 100, and detailed information about the error can be provided via the mobile app.

Disable air bag command 802 sends a command to the vehicle to disable the front passenger seat air bag. If the front seat passenger air bag is disabled, the process stops. If the front passenger seat air bag is not disabled, feedback is provided to the user, where feedback to the user provides a warning that the child seat is located in a front seat but the front seat air bags are not deactivated. The system can recommend the user place the seating component in the rear seat of the vehicle. If a system error occurs during the disable air bag command 802, feedback 804 is also provided to the user. For example, flashing yellow LED's can be triggered on components of system 100, and detailed information about the error can be provided via the mobile app.

Look direction check 806 checks that seating component of the child transportation system 100 is facing in the correct direction for the child's weight, height, and age (if known). Look direction check 806 determines the direction the seating component is facing in the vehicle, queries the result of prior measurement of child weight and height, compares the prior measured weight and height data to stored information that describes the proper seating component orientation for child weights and heights. Look direction check 806 is performed in the same manner as described earlier for look direction checks 439, 574, and 639, so the description will not be repeated here. If look direction check 806 determines that the seating component is facing in the recommended direction for the child weight and height, Isofix base check 813 runs. If look direction check 806 determines the seating component is not facing the correct direction, a communication chain process comprising blocks 807, 808, 809, 810, and 811 runs, where feedback to the user can identify that the seating component is not facing the correct direction. If a system error occurs during the look direction check 806, feedback 812 is also provided to the user. For example, flashing yellow LED's can be triggered on components of system 100, and detailed information about the error can be provided via the mobile app. If look direction check 806 determines that child weight and height data is not available, look direction check 806 stops and Isofix base check 813 runs.

Isofix base check 813 checks that the Isofix base is present. Isofix base check 813 is performed in the same manner as described earlier for Isofix base checks 429, 529, and 629, so the description will not be repeated here. If Isofix base check 813 determines that the Isofix base is present, the Isofix base check 813 completes and the Isofix connector check 829 runs. If the Isofix base check 813 determines that an Isofix base is not present, seat belt routing check 814 runs. If a system error occurs during the Isofix base check 813, feedback 820 is also provided to the user. For example, flashing yellow LED's can be triggered on components of system 100, and detailed information about the error can be provided via the mobile app.

Seat belt routing check 814 checks that the vehicle seat belt is routed through three routing locations on the seating component of system 100. Seat belt routing check 814 is performed in the same manner as described earlier for seat belt routing checks 442, 542, 642, and 722, so the description will not be repeated here. If seat belt routing check 814 determines that the vehicle seat belt is properly routed through three seat belt routing locations on the seating component, the belt routing check completes and seat orientation check 821 runs. If the vehicle seat belt is determined to not be properly routed, a communication chain process comprising blocks 815, 816, 817, 818, and 819 runs, where feedback to the user can identify that the vehicle seat belt is not properly routed. If a system error occurs during the belt routing check 814, feedback 827 is also provided to the user. For example, flashing yellow LED's can be triggered on components of system 100, and detailed information about the error can be provided via the mobile app.

Seat orientation check 821 determines if the seating component is properly oriented in the vehicle. Seat orientation check 821 is performed in the same manner as seat orientation checks 443, 543 and 761 described earlier, so the description will not be repeated here. Seat orientation check 821 measures the seat orientation by comparing outputs from a first IMU located in the seating component handle 195 with the output of a second IMU located in the hub 103, in order to obtain a measurement of the seat orientation in the vehicle frame of reference. The determined orientation is compared with stored information describing a predetermined range of proper orientation within the vehicle. If the measured orientation is within the predetermined range of proper orientation, seat orientation check 821 stops. If seat orientation check 821 determines that the measured orientation is outside of the proper range of orientation, a communication chain process comprising blocks 830, 831, 832, 833, and 834 runs, where feedback to the user can identify that the seat orientation is not within the recommended range. If a system error occurs during the seat orientation check 821, feedback 835 is also provided to the user. For example, flashing yellow LED's can be triggered on components of system 100, and detailed information about the error can be provided via the mobile app.

Isofix connector check 829 checks that the Isofix connectors are properly latched. Isofix connector check 829 is performed in the same manner as described earlier for Isofix connector checks 432, 532, 577, 632, 677, and 729, so the description will not be repeated here. If Isofix connector check 829 determines that the Isofix connectors are properly latched, the Isofix connector check stops. If the Isofix connectors are determined to not be properly latched, a communication chain process comprising blocks 830, 831, 832, 833, and 834 runs, where feedback to the user can identify that the Isofix connectors are not properly latched. If a system error occurs during the Isofix connector check 829, feedback 835 is also provided to the user. For example, flashing yellow LED's can be triggered on components of system 100, and detailed information about the error can be provided via the mobile app.

A number of implementations have been described. Nevertheless, it will be understood that additional modifications may be made without departing from the scope of the inventive concepts described herein, and, accordingly, other embodiments are within the scope of the following claims.

What is claimed is:

1. A child transportation system comprising:
a seating component for placement in a vehicle in which a child can be placed;
a mobile application configured for execution by a remote mobile computing device;
wherein the seating component is in wireless communication with the remote mobile computing device;
wherein the system is constructed and arranged to perform a plurality of checks comprising:
one or more checks to determine if the seating component of the child transportation system is located in a vehicle;
one or more checks to determine if the seating component of the child transportation system located in the vehicle is occupied by a child;
one or more checks to determine if the seating component of the child transportation system is a proper seating component for the child occupying the seating component;
one or more checks to determine if the seating component of the child transportation system is properly installed in the vehicle;
one or more checks to determine if the child located in the seating component of the child transportation system is properly secured in the seating component, and;
one or more checks to determine if the child transportation system is functioning properly.

2. The system of claim 1 wherein a check to determine if the seating component of the system is located in the vehicle comprises determining if a communication link is present between the seating component and the remote mobile computing device.

3. The system of claim 1 wherein a check to determine if the seating component of system located in the vehicle is occupied by a child comprises sensing with an occupancy sensor if the seating component is occupied.

4. The system of claim 3 wherein the check to determine if the seating component of the system is a proper seating component for a child occupying the seating component comprises measuring the child's weight and comparing the measured weight to a stored predetermined threshold weight value.

5. The system of claim 3 wherein a check to determine if a seating component of the system is a proper seating component for a child occupying the seating component comprises obtaining the child's height and comparing the obtained height to a stored predetermined threshold height value.

6. The system of claim 4 wherein a check to determine if the seating component of the system is properly installed in the vehicle comprises determining if the seating component is facing the correct direction in the vehicle, based on the measured weight of the child.

7. The system of claim 1 wherein a check to determine if the seating component of the system is properly installed in the vehicle comprises:
determining by the system if the seating component is located in a front seat of the vehicle,
determining by the system if a communication link exists between the system and the vehicle, and;
wherein if the seating component is determined to be in the front seat and a communication link exists between the system and the vehicle, issuing a command by the system to the vehicle to disable front seat air bags of the vehicle.

8. The system of claim 1 wherein a check to determine if the seating component of the system is properly installed in the vehicle comprises determining if a handle of the seating component is positioned in a reference position for driving.

9. The system of claim 1 wherein a check to determine if the seating component of the system is properly installed in the vehicle comprises determining if an Isofix base is present.

10. The system of claim 9 wherein if an Isofix base is determined to be present, the check to determine if the seating component of the system is properly installed in the vehicle further comprises determining if Isofix connectors associated with the Isofix base are properly latched.

11. The system of claim 9 wherein if an Isofix base is determined not to be present, the check to determine if the seating component of the system is properly installed in the vehicle further comprises determining if a seat belt of the vehicle is properly routed through seat belt routing locations furnished on the seating component.

12. The system of claim 11 wherein if the seat belt of the vehicle is determined to be properly routed through seat belt routing locations furnished on the seating component, a seating component orientation check is performed.

13. The system of claim 1 wherein a check to determine if the seating component of the system is properly installed in the vehicle comprises:
measuring the tension applied to a harness of the seating component, and;
determining if the measured tension applied to the harness is greater than a first stored predetermined threshold tension value.

14. The system of claim 13 wherein the tension is measured using a sensor having a cantilevered beam.

15. The system of claim 1 wherein the system maintains a historical record of checks performed by the system.

16. The system of claim 15 wherein the historical record includes the output from a GPS sub system included as part of the system.

17. The system of claim 1 wherein the plurality of checks are incorporated into a pre-flight check process which can be initiated by a user prior to the start of a vehicle trip, wherein the pre-flight check can be initiated either by actuation of a control surface located on the remote mobile computing device or actuation of a control surface located on the seating component,
wherein execution of the pre-flight check is controlled by the child transportation system,
wherein the child transportation system performs the plurality of checks in succession,
wherein the child transportation system provides feedback to the user if any check fails to complete,
wherein the child transportation system provides feedback to the user that the pre-flight check has passed if all checks included in the plurality of checks complete.

18. The system of claim 1 wherein a subset of the plurality of checks is incorporated into an automatic check process,
wherein the automatic check process is initiated by the child transportation system if a start of a vehicle trip is detected by the system,
wherein the start of a vehicle trip is detected by monitoring a GPS sub system incorporated in the child transportation system,
wherein execution of the automatic check is controlled by the child transportation system,
wherein the child transportation system performs additional checks to determine if environmental conditions are safe, and
wherein the child transportation system provides feedback to the user if any check fails to complete.

19. A method for operating a child transportation system comprising:
determining if a seating component of the child transportation system is located in a vehicle,
determining if the seating component of the child transportation system located in the vehicle is occupied by a child;
determining if the seating component of the system is a proper seating component for the child occupying the seating component;
determining if a seating component of the system is properly installed in a vehicle;
determining if a child located in the seating component is properly secured in the seating component, and;
determining that components of the system are functioning properly.
